(19) United States
(12) Patent Application Publication
(10) Pub. No.: US 2024/0210643 A1
(43) Pub. Date: Jun. 27, 2024

(54) INTERMITTENTLY BONDED OPTICAL FIBER RIBBON WITH REDUCED DIAMETER FIBERS

(71) Applicant: CORNING RESEARCH & DEVELOPMENT CORPORATION, Corning, NY (US)

(72) Inventors: Arash Abedijaberi, Hsinchu City (TW); Scott Robertson Bickham, Corning, NY (US); Julie Ann Chalk, Hickory, NY (US); David Wesley Chiasson, Edmonton (CA); William Carl Hurley, Hickory, NC (US)

(21) Appl. No.: 18/595,828

(22) Filed: Mar. 5, 2024

Related U.S. Application Data
(63) Continuation of application No. PCT/US2022/042290, filed on Sep. 1, 2022.
(60) Provisional application No. 63/245,267, filed on Sep. 17, 2021.

(51) Int. Cl. G02B 6/44

(52) U.S. Cl. CPC G02B 6/4432; G02B 6/448; G02B 6/4486

(57) ABSTRACT

Disclosed are embodiments of an optical fiber ribbon. In the optical fiber ribbon, subunits each include a subunit coating surrounding at least one optical fiber. Bonds are intermittently formed between adjacent subunits. Each bond has a unique longitudinal position along a length of the optical fiber ribbon such that no other bond is located at the unique longitudinal position. Each optical fiber includes a core region, a cladding region surrounding the core region, a primary coating surrounding the cladding region, and a secondary coating surrounding the primary coating. The cladding region defines a glass diameter in a range from 90 microns to 110 microns, and the secondary coating defines an outer diameter of 140 microns to 170 microns. The cladding region has a depressed index region comprising a trench volume of −20% Δ-micron².

### PRIORITY APPLICATION

This application is a continuation of International Patent Application No. PCT/US2022/042290, filed Sep. 1, 2022, which claims the benefit of priority of U.S. Provisional Application No. 63/245,267, filed on Sep. 17, 2021, the content of which is relied upon and incorporated herein by reference in its entirety.

### BACKGROUND

This disclosure pertains to optical fiber ribbons and, in particular, to intermittently bonded optical fiber ribbons including small diameter optical fibers.

Data processing facilities are in need of optical fiber cables having increased fiber density. Increasing the fiber density of a cable, however, requires the balancing of many different parameters. For example, fiber density is easiest to increase by packing loose bundles of fibers into a cable, but managing loose fibers is more difficult than managing, e.g., ribbon arrays. Further, the optical fibers can be made smaller so that more optical fibers fit in a given space. However, this can lead to microbend attenuation sensitivity and a decrease in puncture resistance.

### SUMMARY

According to an aspect, embodiments of the present disclosure relate to an optical fiber ribbon. The optical fiber ribbon includes a plurality of subunits that each have a subunit coating surrounding at least one optical fiber. A plurality of bonds are intermittently formed between adjacent subunits of the plurality of subunits. Each bond of the plurality of bonds has a unique longitudinal position along a length of the optical fiber ribbon such that no other bond of the plurality of bonds is located at the unique longitudinal position. Each of the at least one optical fiber includes a core region, a cladding region surrounding the core region, a primary coating surrounding the cladding region, and a secondary coating surrounding the primary coating. The cladding region defines a glass diameter in a range from 90 microns to 110 microns, and the secondary coating defines an outer diameter of 140 microns to 170 microns. Further, the cladding region includes a depressed index region comprising a trench volume of −20% Δ-micron². According to another aspect, embodiments of the present disclosure relate to an optical fiber ribbon. The optical fiber ribbon includes a plurality of intermittently bonded subunits including at least one optical fiber. Each of the at least one optical fiber has a core region, a cladding region surrounding the core region, a primary coating surrounding the cladding region, and a secondary coating surrounding the primary coating. The cladding region defines a glass diameter in a range from 90 microns to 110 microns. The primary coating has a thickness between the cladding region and the secondary coating in a range of 8 microns to 15 microns and has a Young's modulus of 0.5 MPa or less. The secondary coating has a thickness in a range of 16.5 microns to 24.5 microns and has a Young's modulus of 1500 MPa or greater.

According to still another aspect, embodiments of the present disclosure relate to a method of preparing an optical fiber ribbon. In the method, a plurality of optical fibers are arranged adjacent to each other along a length of the optical fiber ribbon. A coating of a first material is applied around the plurality of optical fibers to create a plurality of subunits. Each subunit of the plurality of subunits includes at least one optical fiber. A plurality of bonds of a second material are intermittently deposited between adjacent subunits of the plurality of subunits. The second material diffuses into the first material creating a diffusion zone of the second material in the first material, and each bond of the plurality of bonds is located at a unique longitudinal position along the length of the optical fiber ribbon. The first material and the second material are cured. Each of the plurality of optical fibers includes a core region, a cladding region surrounding the core region, a primary coating surrounding the cladding region, and a secondary coating surrounding the primary coating. The cladding region defines a glass diameter in a range from 90 microns to 110 microns, and the secondary coating defines an outer diameter of 140 microns to 170 microns. The cladding region has a depressed index region comprising a trench volume of −20% Δ-micron².

It is to be understood that both the foregoing general description and the following detailed description are merely exemplary and are intended to provide an overview or framework to understand the nature and character of the claims.

The accompanying drawings are included to provide a further understanding and are incorporated in and constitute a part of this specification. The drawings are illustrative of selected aspects of the present disclosure, and together with the description serve to explain principles and operation of methods, products, and compositions embraced by the present disclosure.

### BRIEF DESCRIPTION OF THE DRAWINGS

FIG. 1 is partial, perspective view of an intermittently bonded optical fiber ribbon, according to an exemplary embodiment.

FIGS. 2A and 2B depict a schematic representation of an intermittent bonding pattern for a six subunit optical fiber ribbon, according to an exemplary embodiment.

FIGS. 3A and 3B depict a schematic representation of an intermittent bonding pattern based on the golden ratio for a six subunit optical fiber ribbon and for a twelve subunit optical fiber ribbon, respectively, according to an exemplary embodiment.

FIGS. 4A and 4B depict a schematic representation of a triangular and a sawtooth intermittent bonding pattern and parameters for producing same, according to exemplary embodiments.

FIGS. 5A-5C depict maximum intermittent bond lengths for triangular and sawtooth intermittent bonding patterns for six, twelve, and sixteen optical fiber subunits, according to exemplary embodiments.

FIGS. 6A-6C depict maximum intermittent bond lengths for the intermittent bonding pattern based on an irrational number for six, twelve, and sixteen optical fiber subunits, according to exemplary embodiments.

FIG. 7 depicts a partial cross-sectional view of a bond between two optical fiber subunits of the intermittently bonded optical fiber ribbon, according to another exemplary embodiment.

FIG. 8 depicts a top view of an intermittent bond of the optical fiber ribbon, according to an exemplary embodiment.

FIG. 9 depicts a saddle surface at an end of the intermittent bond, according to an exemplary embodiment.

FIG. 10 depicts a relative refractive index profile of a single-mode optical fiber in accordance with some embodiments of the current disclosure.

FIG. 11 depicts a relative refractive index profile of a single-mode optical fiber in accordance with some embodiments of the current disclosure.

FIGS. 12A and 12B depict rounded step-index and graded-index profiles of single-mode optical fibers in accordance with some embodiments of the current disclosure.

FIGS. 13A and 13B depict relative refractive index profiles for manufactured single-mode optical fibers in accordance with some embodiments of the current disclosure.

FIGS. 14A and 14B depict rounded step-index and graded-index profiles with triangular sloped trenches for single-mode optical fibers in accordance with some embodiments of the current disclosure.

FIG. 15 depicts the microbend attenuation penalty (MAP) versus the low-modulus coating thickness for fibers with step-index and trench-assisted fiber profiles and a cladding diameter of 100 microns in accordance with some embodiments of the current disclosure.

FIG. 16 depicts the microbend attenuation penalty (MAP) versus the low-modulus coating thickness for fibers having a trench-assisted fiber profile and a cladding diameter of 100 microns for different moduli of the high-modulus coating in accordance with some embodiments of the current disclosure.

FIG. 17 depicts the puncture resistance versus the low-modulus coating thickness for fibers having a trench-assisted fiber profile and a cladding diameter of 100 microns for different moduli of the high-modulus coating in accordance with some embodiments of the current disclosure.

FIG. 18 depicts the microbend attenuation penalty (MAP) versus the low-modulus coating thickness for fibers having a trench-assisted fiber profile and a cladding diameter of 100 microns for different moduli of the low-modulus coating in accordance with some embodiments of the current disclosure.

FIG. 19 depicts the dependence of the puncture load strength as a function of the cross-sectional area of the high-modulus coating according to the present disclosure.

### DETAILED DESCRIPTION

Various embodiments of the present disclosure relate to an optical fiber ribbon including a plurality of small diameter (about 100 μm) optical fibers that are arranged in subunits intermittently bonded together. Advantageously, the small diameter optical fibers are particularly suitable for intermittently bonded optical fiber ribbons because the small diameter of the optical fibers allows the optical fibers to withstand the twisting and bending associated with folding, rolling, bundling, or otherwise collapsing the optical fiber ribbon for packing into an optical fiber cable. Further, the construction of the small diameter optical fibers in terms of glass diameter, primary coating thickness, and secondary coating thickness provides optical fibers that have low microbending sensitivity and that have high puncture resistance. In addition, the intermittently bonded optical fiber ribbons provide more deployment flexibility, including tighter bending, higher packing density, easier non-contact stripping, and easier positioning for connectorization. These and other aspects and advantages will be described more fully below and in relation to the figures.

In that regard, the present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

Before turning to a discussion of the intermittently bonded optical fiber ribbon, it is noted that the specification and the claims that follow will refer to a number of terms which shall be defined to have the following meanings:

“Optical fiber” refers to a waveguide having a glass portion surrounded by a coating. The glass portion includes a core and a cladding and is referred to herein as a “glass fiber”.

“Radial position”, “radius”, or the radial coordinate “r” refers to radial position relative to the centerline (r=0) of the fiber.

“Refractive index” refers to the refractive index at a wavelength of 1550 nm, unless otherwise specified.

The “refractive index profile” is the relationship between refractive index or relative refractive index and radius. For relative refractive index profiles depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the fiber (e.g. core region and/or any of the cladding regions), it is expressed in terms of its actual or approximate functional dependence, or its value at a particular position within the region, or in terms of an average value applicable to the region as a whole. Unless otherwise specified, if the relative refractive index of a region (e.g. core region and/or any of the cladding regions) is expressed as a single value or as a parameter (e.g. Δ or Δ%) applicable to the region as a whole, it is understood that the relative refractive index in the region is constant, or approximately constant, and corresponds to the single value, or that the single value or parameter represents an average value of a non-constant relative refractive index dependence with radial position in the region. For example, if “i” is a region of the glass fiber, the parameter Δᵢ refers to the average value of relative refractive index in the region as defined by Eq. (1) below, unless otherwise specified. Whether by design or a consequence of normal manufacturing variability, the dependence of relative refractive index on radial position may be sloped, curved, or otherwise non-constant.

“Relative refractive index,” as used herein, is defined in Eq. (1) as:

$${Δ}_{i} ( {r}_{i} ) \% = 100 \frac{( {n}_{i}^{2} - {n}_{ref}^{2} )}{2 {n}_{i}^{2}} \qquad ( 1 )$$

where nᵢ is the refractive index at radial position rᵢ in the glass fiber, unless otherwise specified, and n_{ref} is the reference refractive index, which corresponds to the outer cladding region of the optical fiber unless otherwise specified. In embodiments, the reference refractive index is pure silica glass, which has a value of 1.444 at a wavelength of 1550 nm. As used herein, the relative refractive index is represented by Δ (or “delta”) or Δ% (or “delta %) and its values are given in units of “% ”, unless otherwise specified. Relative refractive index may also be expressed as Δ(r) or Δ(r) %.

The average relative refractive index (Δₐᵥₑ) of a region of the fiber is determined from Eq. (2):

$${Δ}_{ave} = {\int }_{{r}_{inner}}^{{r}_{outer}} \frac{Δ ( r ) dr}{( {r}_{outer} - {r}_{inner} )} \qquad ( 2 )$$

where rᵢₙₙₑᵣ is the inner radius of the region, router is the outer radius of the region, and Δ(r) is the relative refractive index of the region.

The refractive index of an optical fiber profile may be measured using commercially available devices, such as the IFA-100 Fiber Index Profiler (Interfiber Analysis LLC, Sharon, MA USA) or the S14 Refractive Index Profiler (Photon Kinetics, Inc., Beaverton, OR USA). These devices measure the refractive index relative to a measurement reference index, n(r)−nₘₑₐₛ, where the measurement reference index nₘₑₐₛ is typically a calibrated index matching oil or pure silica glass. The measurement wavelength may be 632.5 nm, 654 nm, 677.2 nm, 654 nm, 702.3 nm, 729.6 nm, 759.2 nm, 791.3 nm, 826.3 nm, 864.1 nm, 905.2 nm, 949.6 nm, 997.7 nm, 1050 nm, or any wavelength therebetween. The absolute refractive index n(r) is then used to calculate the relative refractive index as defined by Eq. (1).

The term “α-profile” or “alpha profile” refers to a relative refractive index profile Δ(r) that has the functional form defined in Eq. (3):

$$Δ ( r ) = Δ ( {r}_{0} ) [ 1 - {[ \frac{\vert r - {r}_{0} \vert}{( {r}_{z} - {r}_{0} )} ]}^{α} ] \qquad ( 3 )$$

where rₒ is the radial position at which Δ(r) is maximum, Δ(r₀)>0, r_{z}>r₀ is the radial position at which Δ(r) decreases to its minimum value, and r is in the range rᵢ≤r≤r_{f}, where rᵢ is the initial radial position of the α-profile, r_{f} is the final radial position of the α-profile, and a is a real number. Δ(r₀) for an α-profile may be referred to herein as Δₘₐₓ or, when referring to a specific region i of the fiber, as Δᵢₘₐₓ. When the relative refractive index profile of the fiber core region is described by an α-profile with r₀ occurring at the centerline (r=0), r_{z} corresponding to the outer radius r₁ of the core region, and Δ₁(r₁)=0, Eq. (3) simplifies to Eq. (4):

$${Δ}_{1} ( r ) = {Δ}_{1 max} [ 1 - {[ \frac{r}{{r}_{1}} ]}^{α} ] \qquad ( 4 )$$

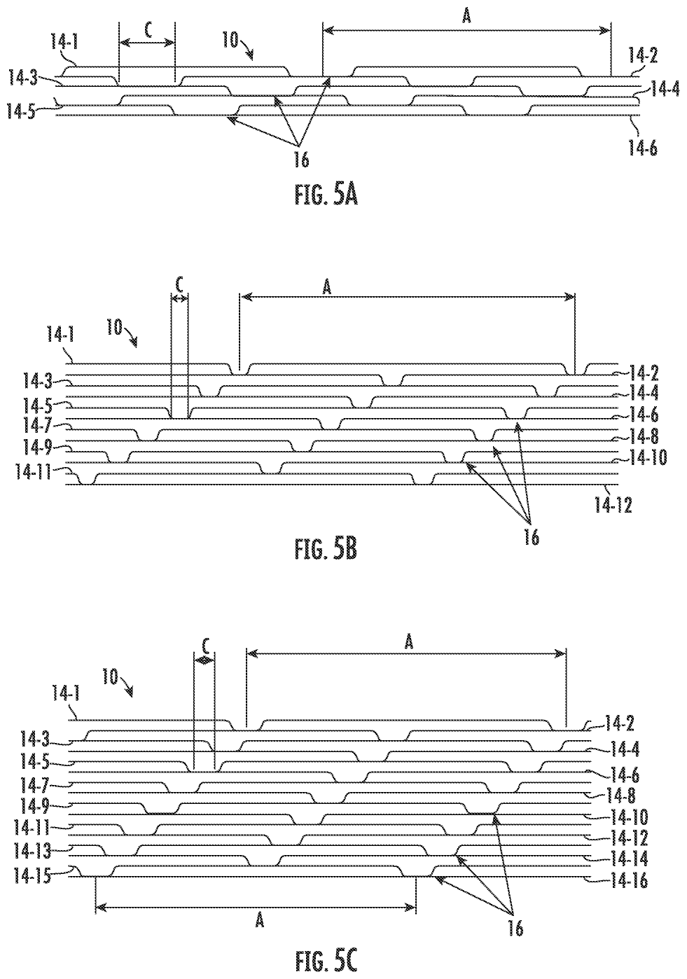

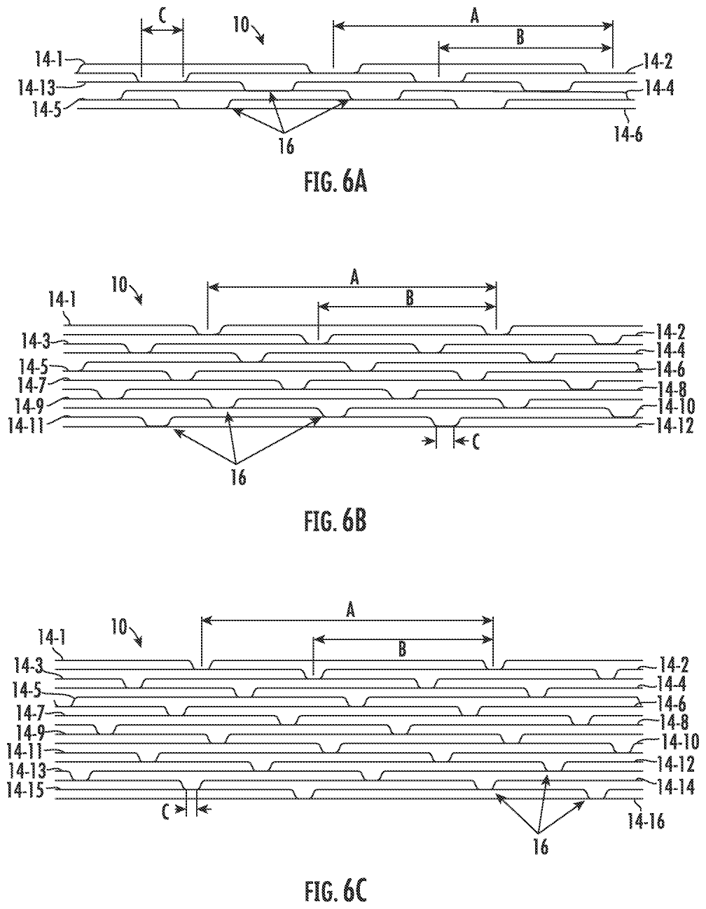

Relative refractive index profiles of representative glass fibers having cores described by an α-profile, in accordance with embodiments of the present disclosure, are shown in FIGS. 5 and 6.

“Trench volume” is defined as:

$${V}_{Trench} = \vert 2 {\int }_{{r}_{Trench , inner}}^{{r}_{Trench , outer}} {Δ}_{Trench} ( r ) rdr \vert \qquad ( 5 )$$

where r_{Trench,inner} is the inner radius of the trench region of the refractive index profile, r_{Trench,outer} is the outer radius of the trench region of the refractive index profile, Δ_{Trench}(r) is the relative refractive index of the trench region of the refractive index profile, and r is radial position in the fiber. Trench volume is in absolute value and a positive quantity and will be expressed herein in units of % Δmicron², % Δ-micron², % Δ-μm², or % Δμm², whereby these units can be used interchangeably herein. A trench region is also referred to herein as a depressed-index cladding region and trench volume is also referred to herein as V₃.

The “mode field diameter” or “MFD” of an optical fiber is defined in Eq. (6) as:

$$M F D = 2 w \qquad ( 6 )$$

$${w}^{2} = 2 \frac{{\int }_{0}^{∞} {( f ( r ) )}^{2} rdr}{{\int }_{0}^{∞} {( \frac{df ( r )}{dr} )}^{2} rdr}$$

where f(r) is the transverse component of the electric field distribution of the guided optical signal and r is radial position in the fiber. “Mode field diameter” or “MFD” depends on the wavelength of the optical signal and is reported herein for wavelengths of 1310 nm, 1550 nm, and 1625 nm. Specific indication of the wavelength will be made when referring to mode field diameter herein. Unless otherwise specified, mode field diameter refers to the LP₀₁ mode at the specified wavelength.

“Effective area” of an optical fiber is defined in Eq. (7) as:

$${A}_{eff} = \frac{2 {π [ {\int }_{0}^{∞} {( f ( r ) )}^{2} rdr ]}^{2}}{{\int }_{0}^{∞} {( f ( r ) )}^{4} rdr} \qquad ( 7 )$$

where f(r) is the transverse component of the electric field of the guided optical signal and r is radial position in the fiber. “Effective area” or “A_{eff}” depends on the wavelength of the optical signal and is understood herein to refer to a wavelength of 1550 nm.

The term “attenuation,” as used herein, is the loss of optical power as the signal travels along the optical fiber. Attenuation was measured as specified by the IEC-60793-1-40 standard, “Attenuation measurement methods.”

The bend resistance of an optical fiber, expressed as “bend loss” herein, can be gauged by induced attenuation under prescribed test conditions as specified by the IEC-60793-1-47 standard, “Measurement methods and test procedures—Macrobending loss.” For example, the test condition can entail deploying or wrapping the fiber one or more turns around a mandrel of a prescribed diameter, e.g., by wrapping one turn around either a 15 mm, 20 mm, or 30 mm or similar diameter mandrel (e.g. “1×15 mm diameter bend loss” or the “1×20 mm diameter bend loss” or the “1×30 mm diameter bend loss”) and measuring the increase in attenuation per turn.

“Cable cutoff wavelength,” or “cable cutoff,” as used herein, refers to the 22 m cable cutoff test as specified by the IEC 60793-1-44 standard, “Measurement methods and test procedures—Cut-off wavelength.”

The optical fibers disclosed herein include a core region, a cladding region surrounding the core region, and a coating surrounding the cladding region. The core region and cladding region are glass. The cladding region includes multiple regions. The multiple cladding regions are preferably concentric regions. The cladding region includes an inner cladding region, a depressed-index cladding region, and an outer cladding region. The inner cladding region surrounds and is directly adjacent to the core region. The depressed-index cladding region surrounds and is directly adjacent to the inner cladding region such that the depressed-index cladding region is disposed between the inner cladding and the outer cladding in a radial direction. The outer cladding region surrounds and is directly adjacent to the depressed-index cladding region. The depressed-index cladding region has a lower relative refractive index than the inner cladding and the outer cladding region. The depressed-index cladding region may also be referred to herein as a trench or trench region. The relative refractive index of the inner cladding region may be less than, equal to, or greater than the relative refractive index of the outer cladding region. The depressed-index cladding region may contribute to a reduction in bending losses and microbending sensitivity. The core region, inner cladding region, depressed-index cladding region, and outer cladding region are also referred to as core, cladding, inner cladding, depressed-index cladding, and outer cladding, respectively.

Whenever used herein, radial position r₁ and relative refractive index Δ₁ or Δ₁(r) refer to the core region, radial position r₂ and relative refractive index Δ₂ or Δ₂(r) refer to the inner cladding region, radial position r₃ and relative refractive index Δ₃ or Δ₃(r) refer to the depressed-index cladding region, radial position r₄ and relative refractive index Δ₄ or Δ₄(r) refer to the outer cladding region, radial position r₅ refers to the low-modulus inner coating, radial position r₆ refers to the high-modulus coating, and the radial position r₇ refers to the optional pigmented outer coating.

The relative refractive index Δ₁(r) has a maximum value Δ₁ₘₐₓ and a minimum value Δ₁ₘᵢₙ. The relative refractive index Δ₂(r) has a maximum value Δ₂ₘₐₓ and a minimum value Δ₂ₘᵢₙ. The relative refractive index Δ₃(r) has a maximum value Δ₃ₘₐₓ and a minimum value Δ₃ₘᵢₙ. The relative refractive index Δ₄(r) has a maximum value Δ₄ₘₐₓ and a minimum value Δ₄ₘᵢₙ. In embodiments in which the relative refractive index is constant or approximately constant over a region, the maximum and minimum values of the relative refractive index are equal or approximately equal. Unless otherwise specified, if a single value is reported for the relative refractive index of a region, the single value corresponds to an average value for the region.

It is understood that the central core region is substantially cylindrical in shape and that the surrounding inner cladding region, depressed-index cladding region, outer cladding region, low-modulus coating, and high-modulus coating are substantially annular in shape. Annular regions are characterized in terms of an inner radius and an outer radius. Radial positions r₁, r₂, r₃, r₄, r₅, r₆ and r₇ refer herein to the outermost radii of the core, inner cladding, depressed-index cladding, outer cladding, low-modulus inner coating, high-modulus coating, and optional pigmented outer coating, respectively. The radius r₆ also corresponds to the outer radius of the optical fiber in embodiments without a pigmented outer coating. The pigmented outer coating may have a high modulus. When a pigmented outer coating is present, the radius r₇ corresponds to the outer radius of the optical fiber.

When two regions are directly adjacent to each other, the outer radius of the inner of the two regions coincides with the inner radius of the outer of the two regions. The optical fiber, for example, includes a depressed-index cladding region surrounded by and directly adjacent to an outer cladding region. The radius r₃ corresponds to the outer radius of the depressed-index cladding region and the inner radius of the outer cladding region. The relative refractive index profile also includes a depressed-index cladding region surrounding and directly adjacent to an inner cladding region. The radial position r₂ corresponds to the outer radius of the inner cladding region and the inner radius of the depressed-index cladding region. Similarly, the radial position r₁ corresponds to the outer radius of the core region and the inner radius of the inner cladding region.

The difference between radial position r₂ and radial position r₁ is referred to herein as the thickness of the inner cladding region. The difference between radial position r₃ and radial position r₂ is referred to herein as the thickness of the depressed-index cladding region. The difference between radial position r₄ and radial position r₃ is referred to herein as the thickness of the outer cladding region. The difference between radial position r₅ and radial position r₄ is referred to herein as the thickness of the low-modulus coating. The difference between radial position r₆ and radial position r₅ is referred to herein as the thickness of the high-modulus coating.

As will be described further hereinbelow, the relative refractive indices of the core region, inner cladding region, depressed-index cladding region, and outer cladding region may differ. Each of the regions may be formed from doped or undoped silica glass. Variations in refractive index relative to undoped silica glass are accomplished by incorporating updopants or downdopants at levels designed to provide a targeted refractive index or refractive index profile using techniques known to those of skill in the art. Updopants are dopants that increase the refractive index of the glass relative to the undoped glass composition. Downdopants are dopants that decrease the refractive index of the glass relative to the undoped glass composition. In one embodiment, the undoped glass is silica glass. When the undoped glass is silica glass, updopants include Cl, Br, Ge, Al, P, Ti, Zr, Nb, and Ta, and downdopants include Fluorine and Boron. Regions of constant refractive index may be formed by not doping or by doping at a uniform concentration over the thickness of the region. Regions of variable refractive index are formed through non-uniform spatial distributions of dopants over the thickness of a region and/or through incorporation of different dopants in different regions.

Values of Young's modulus, % elongation, and tear strength refer to values as determined under the measurement conditions by the procedures described herein.

Reference will now be made in detail to illustrative embodiments of the present description.

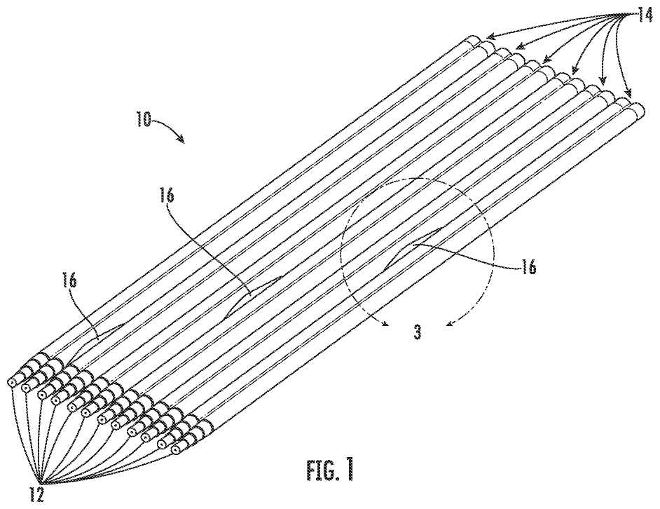

Referring to FIG. 1, an embodiment of an optical fiber ribbon 10 according to the present disclosure is depicted. The optical fiber ribbon 10 includes a plurality of optical fibers 12. In one or more embodiments, including the embodiment depicted, the optical fiber ribbon 10 includes twelve optical fibers 12. In one or more embodiments, the number of optical fibers 12 contained in the optical fiber ribbon 10 varies from, e.g., four to thirty-six. In certain embodiments, the optical fibers 12 are grouped into subunits 14 having one or more optical fibers 12. In one or more embodiments, such as the embodiment shown in FIG. 1, the subunits 14 each include two optical fibers 12. Thus, for example, in the embodiment of FIG. 1, the optical fibers 12 are arranged into six subunits 14. The optical fibers 12 of each subunit 14 are bonded to each other along the length of the optical fiber ribbon 10, but the subunits 14 are only intermittently bonded along the length of the optical fiber ribbon 10.

FIG. 1 depicts intermittent bonds 16 staggered along the length of the subunits 14. The intermittent bonds 16 between two adjacent subunits 14 may be spaced apart by, e.g., 15 mm to 200 mm. In one or more embodiments, the intermittent bonds 16 are applied in a “wet-on-wet” application process, which creates diffusion of the material of the intermittent bond 16 with a coating material of the subunits 14. In embodiments, the optical fiber ribbon 10 has a first configuration in which the optical fibers 12 are arranged in a substantially planar row, which helps to organize the optical fibers 12 for mass fusion splicing. Further, as will be described more fully below, the subunits 14 also can be rolled, folded, curled, or bundled into a non-planar configuration (e.g., a circle or spiral) for space-saving packaging in an optical fiber cable, especially optical fiber cables having a circular cross-section. The optical fibers 12 of the optical fiber ribbon 10 are able to transition from the first configuration to the second configuration because the subunits 14 are only held together intermittently along the length of the optical fiber 10 by the intermittent bonds 16.

In a conventional optical fiber ribbon, each optical fiber is bonded to its neighboring optical fiber(s) along the entire length of the optical fiber ribbon to hold them in the planar configuration. According to one or more embodiments of the present disclosure, however, the fiber subunits 14 are bonded intermittently along the length of the optical fiber ribbon 10 so that the optical fibers 12 are not rigidly held in the planar configuration. In between the intermittent bonds 16, the subunits 14 are not bonded to each other along their length. In this way, the present optical fiber ribbon 10 provides the advantages of a ribbon with respect to fiber organization and mass fusion splicing while also allowing the optical fiber ribbon 10 to curl, roll, fold, or bundle across the width of the ribbon allowing for a more compact cable design.

In order to provide a compact ribbon design, the intermittent bonds 16 are applied between the subunits 14 in such a manner that the intermittent bonds 16 do not overlap across the width of the optical fiber ribbon 10. That is, no two intermittent bonds 16 have the same longitudinal position on the optical fiber ribbon 10. Put differently, each intermittent bond 16 has a unique longitudinal position on the optical fiber ribbon 10 that is not shared by any other intermittent bond 106 along the length of the optical fiber ribbon 10. If the intermittent bonds were to overlap, the material of the bonds would concentrate at locations along the length of the ribbon and thus result in an increase in the rigidity of the optical fiber ribbon across the width at these discrete locations, decreasing the ability of the optical fiber ribbon to curl, fold, or bundle.

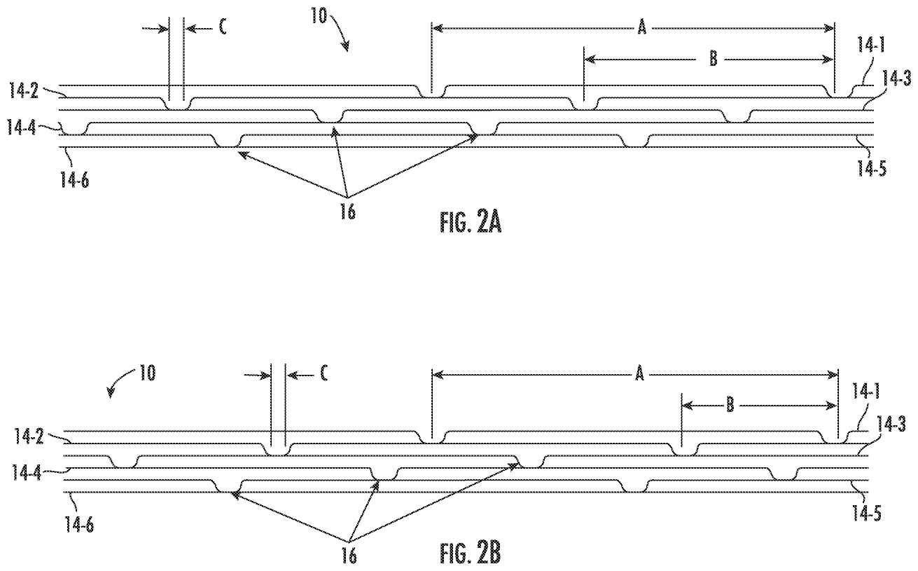

FIG. 2A depicts a schematic representation of the intermittent bonding pattern for the optical fiber ribbon 10. In the depiction of FIG. 2A, the lines represent subunits 14 of one or more optical fibers 12 (e.g., two optical fibers 12 as shown in FIG. 1), and individual subunits are referenced as 14-1, 14-2, . . . 14-n. In the embodiment shown in FIG. 2A, there are six subunits 14-1, 14-2, 14-3, 14-4, 14-5, 14-6. The regions where one subunit 14 dips to contact an adjacent subunit 14 represent intermittent bonds 16 between the subunits 14. It should be noted that the dips depicted in FIG. 2A are used to illustrate the intermittent bonds 16 and do not indicate that the subunits 14 would actually physically dip at the locations of intermittent bonds 16. In order to describe the intermittent bonding pattern in embodiments, three parameters are utilized. The first parameter “A” refers to the longitudinal distance between intermittent bonds 16 joining a particular pair of subunits 14 (e.g., the longitudinal distance between intermittent bonds 16 joining subunit 14-1 and subunit 14-2). The second parameter “B” refers to the longitudinal offset between the intermittent bonds 16 of adjacent pairs of subunits 14. Thus, for example, second parameter B refers to the offset between the intermittent bond 16 of the subunit pair 14-1, 14-2 and the intermittent bond 16 of the subunit pair 14-2, 14-3. In certain instances, the second parameter B is referred to as a fraction or multiple of the first parameter A. The third parameter “C” refers to the length of each intermittent bond 16. In certain instances, the third parameter C is also referred to as a fraction or multiple of the first parameter A.

The intermittent bonds 16 occur at interfaces between subunits 14. The number of interfaces X is equal to one fewer than the number (N) of subunits 14 in the optical fiber ribbon 10 (i.e., X=N−1). Thus, for example, an optical fiber ribbon 10 with six subunits 14 will have five interfaces. Particular interfaces may be referenced herein with a slash between the numbered subunits (e.g., the interface between subunit 14-1 and subunit 14-2 may be referenced as “interface 14-1/14-2”). In order to provide an optical fiber ribbon 10 without overlap of intermittent bonds 16, Applicant has found that a direct correlation exists between the divisor of the offset parameter B and the number of interfaces. In particular, no overlap will exist if the offset parameter B is equal to the number of interfaces divided by a divisor that is greater than the number of interfaces. For example, in a six subunit optical fiber ribbon 10, no overlap will exist for an offset parameter B of (⅝)A (i.e., the divisor (8) is greater than the number of interfaces (5)). Additionally, as shown in FIG. 2B, the complement to the fraction (e.g., (⅜)A) will also produce an offset that produces no overlap.

In embodiments, the offset parameter B is equal to a fraction of A close to 0.5 that corresponds to the number of interfaces X divided by a divisor equal to 2(X−1). Thus, in embodiments, the offset parameter B is equal to (X/(2(X−1))A or its complement. For example, the offset parameter B for an optical fiber ribbon 10 having twelve subunits 14 and eleven interfaces may be equal to ( 11/20)A or ( 9/20)A.

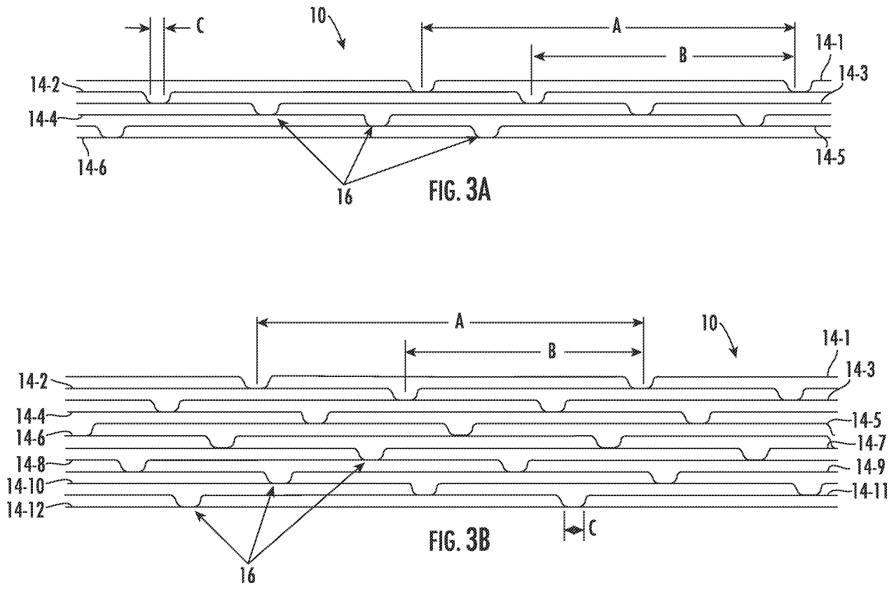

In still other embodiments, the offset parameter B is based on an irrational number, in particular an irrational number that is close to 0.5, in order to avoid overlapping of the intermittent bonds 106. In a particular embodiment, the offset parameter B is based on the golden ratio φ=(1+√5)/2=1.6180339887. Specifically, the offset parameter B=A/φ. FIGS. 3A and 3B show optical fiber ribbons 10 having six subunits 14 and twelve subunits 14, respectively, in which the offset parameter B is A/φ. As can be seen in FIGS. 3A and 3B, the intermittent bonds 16 do not overlap across the width of the optical fiber ribbon 10, and each intermittent bond 16 has a unique longitudinal position along the length of the optical fiber ribbon 10. In other embodiments, the offset parameter B can be based on such irrational numbers as √2, √3, √5, √7, Euler's number, or π. For example, the offset parameter B may be the first parameter A divided by, e.g., one of the irrational numbers, an integer multiple of one of the irrational numbers, the sum or difference of an integer and one of the irrational numbers, etc.

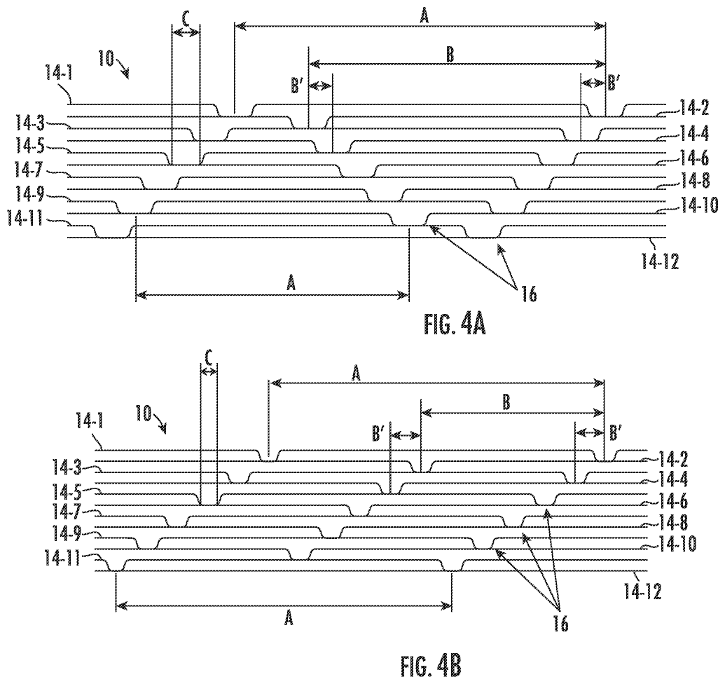

In further embodiments, the intermittent bonding pattern is a triangular or sawtooth bonding pattern. As shown in FIG. 4A, four parameters are used to define the triangular pattern. In such embodiments, the first parameter A still refers to the longitudinal distance between intermittent bonds 16 joining a particular pair of subunits 14. The second parameter B refers to the offset between an intermittent bond 16 at interface 14-1/14-2 and an intermittent bond 16 at interface 14-2/14-3. In embodiments, the second parameter B is from half the first parameter A to less than the first parameter A (i.e., 0.5A≤B<A). The third parameter C still refers to the length of the intermittent bond. The fourth parameter B′ refers to the distance between intermittent bonds 106 at successive odd interfaces (14-1/14-2, 14-3/14-4, . . . ) and at successive even interfaces (14-2/14-3, 14-4/14-5, . . . ). In embodiments, the sign of the fourth parameter B′ may be the same for the intermittent bonds 16 at the even interfaces and at the odd interfaces, and in other embodiments, the sign of the fourth parameter B′ may be different for the intermittent bonds 16 at the even interfaces and at the odd interfaces.

In embodiments of the triangular bonding pattern shown in FIG. 4A, the second parameter B is set at about A*((X−0.5)/X) in which X is the number of interfaces between subunits 14 of the optical fiber ribbon 10 or one fewer than the number of subunits 14. Further, in particular embodiments of the triangular bonding pattern, the fourth parameter B′ is equal to A/X. In the case of a twelve subunit 14 optical fiber ribbon 10, the second parameter B is equal to about 0.95A (i.e., Δ(11−0.5)/11), and the fourth parameter B′ is about 0.09A (i.e., A/11). Further, in the embodiment of FIG. 4A, the odd and even interfaces are offset in the opposite direction defining the triangular bonding pattern. That is, starting from the first odd interface 14-1/14-2, the subsequent odd interfaces (14-3/14-4, 14-5/14-6, . . . ) are offset to the left, whereas starting from the first even interface 14-2/14-3, the subsequent even interfaces (14-4/14-5, 14-6/14-7, . . . ) are offset to the right.

In the embodiment shown in FIG. 4B, a sawtooth bonding pattern is shown using the same four parameters as the triangular bonding pattern. In a particular embodiment of the sawtooth bonding pattern, the second parameter B is set at about A*((X/2+0.5)/X). The fourth parameter B′ is A/X. Besides the difference in the second parameter B, the sawtooth bonding pattern differs from the triangular bonding pattern in that the sign of the fourth parameter B′ is the same for the intermittent bonds 16 at the odd and even interfaces. That is, starting from the first odd interface 14-1/14-2, the subsequent odd interfaces (14-3/14-4, 14-5/14-6, . . . ) are offset to the left, and starting from the first even interface 14-2/14-3, the subsequent even interfaces (14-4/14-5, 14-6/14-7, . . . ) are also offset to the left. In both the triangular bonding pattern and the sawtooth bonding pattern, though, there is no overlap of the center of the intermittent bonds 16 across the width of the optical fiber ribbon 10.

Applicant found that the first parameter A had the greatest impact on the global and local out-of-plane deflection. In particular, Applicant found that a spacing of 15 mm to 200 mm, in particular 30 mm to 150 mm, and most particularly 70 mm to 80 mm, provided a desirable balance between global and local out-of-plane deflection.

While it was determined that the spacing of parameter A was the dominant factor with respect to local and global out-of-plane deflection, optimal intermittent bond 16 lengths were also determined. FIG. 5A depicts an optical fiber ribbon 10 with six subunits 14 in the triangular or sawtooth pattern. Parameters A and C are depicted. As mentioned, parameter A is selected to be 15 mm to 200 mm. Parameter C, relating to the bond length, was determined to have a maximum dimension of 0.2A for the six subunit 14 embodiment. FIG. 5B depicts an optical fiber ribbon 10 with twelve subunits 14 having the triangular or sawtooth pattern. For this embodiment, parameter C was determined to have a maximum dimension of 0.091A. FIG. 5C depicts an optical fiber ribbon 10 with sixteen subunits 14 having the triangular or sawtooth pattern. For this embodiment, parameter C was determined to have a maximum dimension of 0.067A.

FIG. 6A depicts an optical fiber cable 10 with six subunits 14 having a bonding pattern based on an irrational number, in particular the golden ratio. Parameters A and C are depicted. As mentioned, parameter A is selected to be 15 mm to 200 mm. Parameter C, relating to the bond length, was determined to have a maximum dimension of 0.15A. FIG. 6B depicts an optical fiber cable 10 with twelve subunits 14 having a bonding pattern based on the golden ratio. Parameter C was determined to have a maximum dimension of 0.056A. FIG. 6C depicts an optical fiber cable 10 with sixteen subunits 14 having a bonding pattern based on the golden ratio. Parameter C was determined to have a maximum dimension of 0.034A.

Thus, using the intermittent bonding patterns described herein, overlap between intermittent bonds 16 of the subunits 14 across the width of the optical fiber ribbon 10 can be avoided, which improves flexibility and allows for the optical fiber ribbon to assume a compact cross-section for placement in an optical fiber cable.

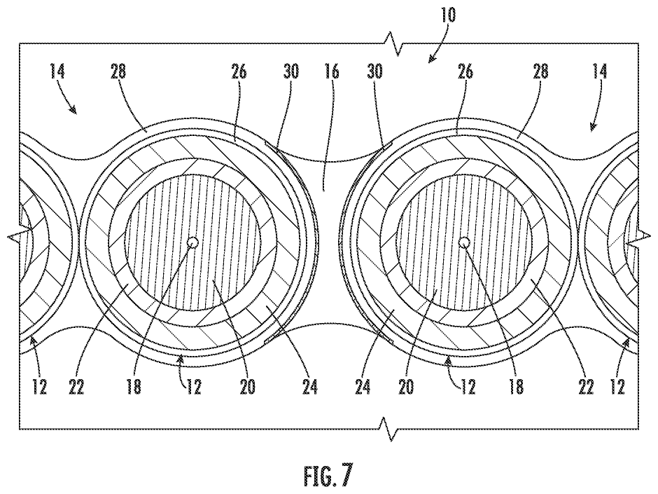

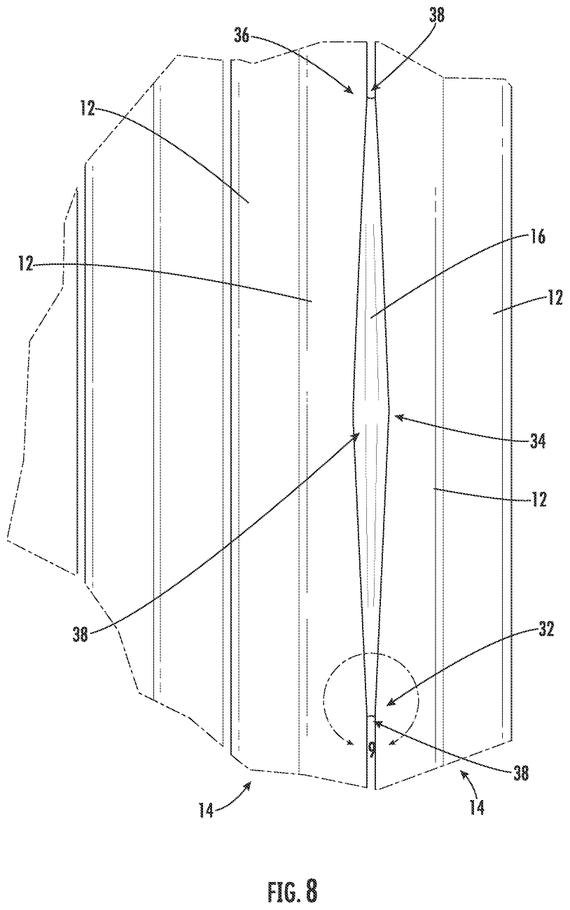

FIG. 7 depicts a cross-section of an intermittent bond 16 between subunits 14. As can be seen in the cross-section of FIG. 7, each optical fiber 12 includes a core 18 arranged substantially at the center of the optical fiber 12. Surrounding the core 18 is a cladding 20. An optical signal travels along the core 18 through internal reflection from the cladding 20. In embodiments, the cladding 20 is surrounded by a primary coating 22, which in turn may be surrounded by a secondary coating 24. The primary coating 22 and secondary coating 24 protect the core 18 and cladding 20. Further, in embodiments, the secondary coating 24 is surrounded by a color layer 26. The color layer 26 may be used to arrange the optical fibers 12 in a color-coded pattern. For example, one convention for color-coding the optical fibers 12 is to arrange them in the following color sequence: blue, orange, green, brown, slate, white, red, black, yellow, violet, rose, and aqua (going from upper left to lower right with respect to the orientation of FIG. 1). In embodiments containing more than twelve optical fibers 12, the pattern of colors may be repeated. The optical fibers 12 are color coded in this way to help organize and identify specific fibers 12 when making connections or splices.

As can be seen in FIG. 7, the optical fibers 12 of each subunit 14 are connected by a subunit coating 28. The subunit coating 28 joins the optical fibers 12 of each subunit 14 along their length. In embodiments, the optical fibers 12 in each subunit 14 may be touching or separated by a space of no more than 1.5 times the diameter of the optical fibers 12 within the ribbon 10. Further, in embodiments, a gap between adjacent subunits 14 may be between 5 μm and 100 μm. At various intervals along the length of the optical fiber ribbon 10, intermittent bonds 16 are disposed in the gap between adjacent subunits 14. The intermittent bond 16 is applied prior to curing of the subunit coating 28, and the intermittent bond 16 and subunit coating 28 are cured together. As such, the intermittent bond 16 material and the subunit coating 28 material are both wet, i.e., uncured, when the intermittent bond 16 material is applied to the optical fiber ribbon 10. As shown in FIG. 7, this “wet-on-wet” application produces a diffusion zone 30 of the material of the intermittent bond 16 into the material of the subunit coating 28, and vice versa.

Outside of the diffusion zone 30, the material of the intermittent bond 16 has first properties, and the material of the subunit coating 28 has second properties. Within the diffusion zone 30, a gradient between the first properties and the second properties exists. In embodiments, the gradient of properties includes at least one of color, Young's modulus, surface friction, ultimate tear strength, or elongation at break, among others. Thus, for example, the material of the intermittent bond 16 may have a first Young's modulus, and the material of the subunit coating 28 may have a second Young's modulus that is greater than the first Young's modulus. In the diffusion zone 30, the Young's modulus will decrease from the second Young's modulus in a region of the subunit coating 28 just outside of the diffusion zone 30 to the first Young's modulus in a region of the intermittent bond 16 just outside of the diffusion zone 30. In embodiments, the gradient of the property in the diffusion zone 30 may be linear, exponential, geometric, etc. In embodiments, the diffusion zone 30 has a thickness between about 2 μm and about 50 μm, in particular, between about 5 μm and about 15 μm.

In embodiments, formation of the diffusion zone 30 is facilitated by using miscible resins for the intermittent bond 16 material and the subunit coating 28 material. By using miscible resins, the material of the intermittent bond 16 will more readily mix with the material of the subunit coating 28. Further, besides miscibility, a relatively thicker diffusion zone 30 can be created using other material properties, such as reduced coating viscosities, to promote intermixing of the intermittent bond 16 and subunit coating 28 materials. In embodiments, the resin of the intermittent bond 16 may be immiscible in the resin of the subunit coating 28 but is at least not insoluble in the resin of the subunit coating 28, and in certain embodiments, the resin of the intermittent bond 16 is at least slightly soluble in the resin of the subunit coating 28. In embodiments, the diffusion zone 30 may also be characterized as providing a region of molecular entanglement between the material of the intermittent bond 16 and the material of the subunit coating 28. For example, the diffusion zone 30 may provide an interface between the intermittent bond 16 and subunit coating 28 in which a mechanical bond is created, e.g., as a result of microscopic mechanical surface undulations of the intermittent bond 16 and subunit coating 28.

Because the material of the intermittent bonds 16 mixes or entangles with the material of the subunit coating 28, significant adhesive/cohesive strength is provided at the location of the intermittent bond 16. During separation of the optical fibers 12 or subunits 14, any failure will either occur within one of the materials (depending on the cross-sectional area and cohesive strength of the material) or at an interface between the subunit coating 28 and the color layer 26.

The diffusion zone 30 distinguishes the presently disclosed intermittently bonded optical fiber ribbon 10 from other optical fiber ribbons that utilize “wet-on-dry” deposition techniques. In wet-on-dry deposition techniques, the coating layer to which the bonding material is applied is at least partially cured or fully cured. In this way, the “wet” bonding material does not have a chance to diffuse into or mix/entangle with the “dry” coating material to create a diffusion zone having a gradient of properties between those of the bonding material and those of the coating material.

Further, using the presently disclosed “wet-on-wet” process, the shape of the intermittent bond 16 also distinguishes the optical fiber ribbon 10 from other conventional optical fiber ribbons. Referring now to FIG. 8, a top view of an intermittent bond 16 between subunits 14 is shown. The top and bottom of the intermittent bond 16 has a generally diamond-shaped outline in which a narrow first end 32 of the intermittent bond 16 widens to a maximum width in a central region 34 of the intermittent bond 16 and narrows again at a second end 36. The intermittent bond thickness at the minimum distance between the subunits, however, maintains a constant thickness and thus a constant distance between the two subunits. Further, the surface geometry of the intermittent bond 16 includes a plurality of saddle points 38. As used herein, a “saddle point” refers to an intersection point of two convex and concave curves where each curve is defined by a plane that has a normal vector parallel to the surface of the bond feature. The saddle point is defined by the intersection of the curves where the plane that defines the convex curve and the plane that defines the concave curve are orthogonal. Both of these orthogonal planes are parallel to a reference plane of the ribbon. In such an instance, the saddle point is where the slopes in orthogonal directions are all zero, e.g., where a relative minimum and a relative maximum intersect at orthogonal planes. In embodiments, the intermittent bond 16 includes saddle points 38 located at the first end 32, the second end 36, or both the first end 32 and the second end 36. In embodiments, a saddle point is also located at the top and bottom surfaces of the bond located at the central region 34.

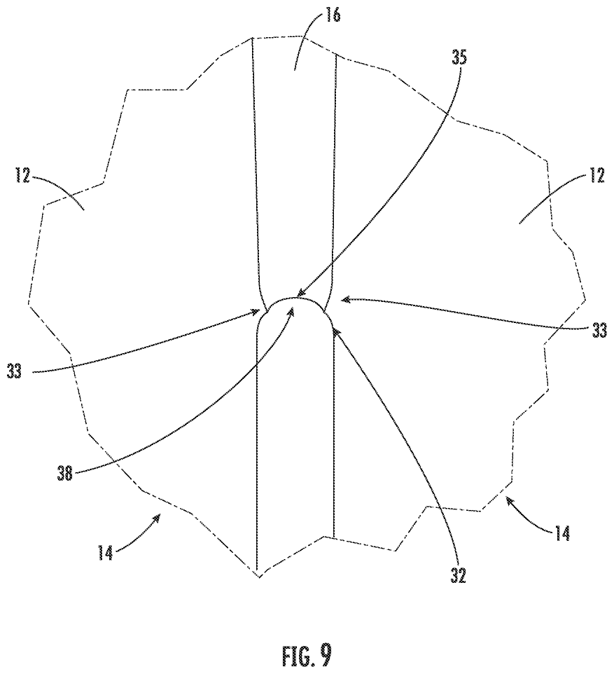

As can be seen in the detail view of FIG. 9, the first end 32 has a concave curvature in which the edge portions 33 (of the material surrounding the fibers) adjacent the optical fibers 12 extend past the middle portion 35 and perhaps bridge the gap between the fibers.

### Glass Fiber

As shown in FIG. 7, glass fiber 12 includes a core region 18 and a cladding region 20, as is known in the art. Core region 18 has a higher refractive index than cladding region 20, and glass fiber 12 functions as a waveguide. In many applications, core region 18 and cladding region 20 have a discernible core-cladding boundary. Alternatively, core region 18 and cladding region 20 can lack a distinct boundary.

In some embodiments, core region 18 has a refractive index that varies with distance from the center of the glass fiber. For example, core region 18 may have a relative refractive index profile with an α-profile (as defined by Eq. (3) above) with an a value that is greater than or equal to 2 and less than or equal to 100, or for example an α value that is greater than or equal to 2 and less than or equal to 10, or greater than or equal to 2 and less than or equal to 6, or greater than or equal to 2 and less than or equal to 4, or greater than or equal to 4 and less than or equal to 20, or greater than or equal to 6 and less than or equal to 20, or greater than or equal to 8 and less than or equal to 20, or greater than or equal to 10 and less than or equal to 20, or greater than or equal to 10 and less than or equal to 40.

As discussed above, optical fiber 12 may have a reduced coating diameter compared to optical fibers having outer diameters of 200 μm or greater. Such reduced diameter(s) may increase the fiber density (e.g., “fiber count”) of optical fibers 12. In order to provide low attenuation, large effective area, low bend loss and high resistance to punctures and abrasions with the smaller diameter of optical fiber 12, the properties of the fiber are specifically tailored, as discussed further below.

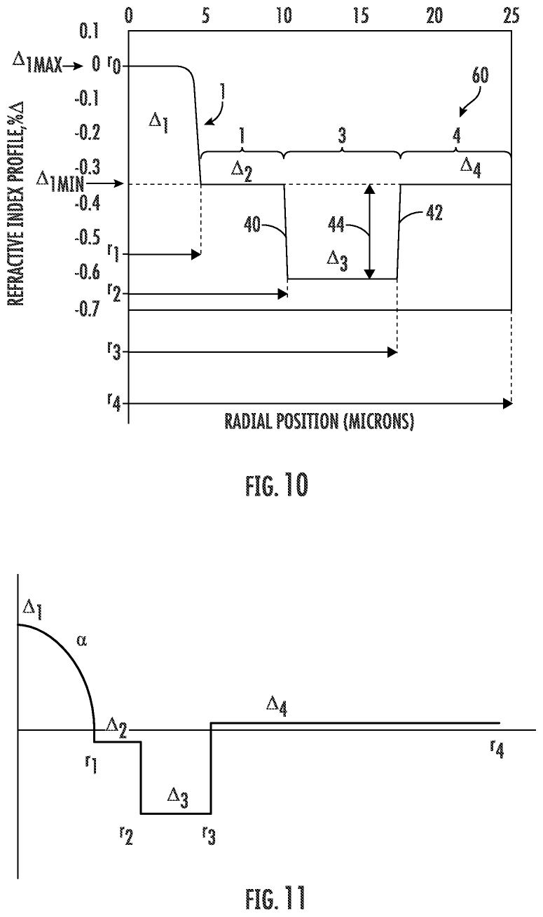

A representative relative refractive index profile for a glass fiber, according to embodiments of the present disclosure, is shown in FIG. 10. The profile of optical fiber 60 of FIG. 10 shows a core region (1) with outer radius r₁ and relative refractive index √1 with maximum relative refractive index Δ₁ₘₐₓ, an inner cladding region (2) extending from radial position r₁ to radial position r₂ and having relative refractive index Δ₂, a depressed-index cladding region (3) extending from radial position r₂ to radial position r₃ and having relative refractive index Δ₃, and an outer cladding region (4) extending from radial position r₃ to radial position r₄ and having relative refractive index Δ₄. In the profile of FIG. 10, the depressed-index cladding region (3) may be referred to herein as a trench and has a constant or average relative refractive index that is less than the relative refractive indices of the inner cladding region (2) and the outer cladding region (4). Core region (1) has the highest average and maximum relative refractive index in the profile. In some embodiments, core region (1) may include a lower index region at or near the centerline (known in the art as a “centerline dip”) (not shown). In some embodiments, core region (1) may include a higher index region at or near the centerline (referred to as a “centerline spike”) (not shown).

In the relative refractive index profile of FIG. 10, the core region (1) of the glass fiber is a rounded step index profile characterized by an a value greater than or equal to 10 and less than or equal to 100.

A representative relative refractive index profile for a glass fiber, according to embodiments of the present disclosure, is shown in FIG. 11. In the embodiment shown in FIG. 11, the core region has an α-profile with an α value greater than or equal to 2 and less than 10. The radial position r₀ (corresponding to Δ₁ₘₐₓ) of the α-profile corresponds to the centerline (r=0) of the fiber and the radial position r_{z} of the α-profile corresponds to the core radius r₁. In embodiments with a centerline dip, the radial position r₀ may be offset from the centerline of the fiber. In some embodiments, the relative refractive index Δ₁ continuously decreases in the radial direction away from the centerline. In other embodiments, relative refractive index Δ₁ varies over some radial positions between the centerline and r₁, and also includes a constant or approximately constant value over other radial positions between the centerline and r₁.

In FIGS. 10 and 11, transition region 40 from inner cladding region (2) to depressed-index cladding region (3) and transition region 42 from depressed-index cladding region (3) to outer cladding region (4) are shown as step changes. It is to be understood that a step change is an idealization and that transition region 40 and/or transition region 42 may not be strictly vertical in practice as depicted in FIGS. 10 and 11. Instead, transition region 40 and/or transition region 42 may have a slope or curvature. When transition region 40 and/or transition region 42 are non-vertical, the inner radius r₂ and outer radius r₃ of depressed-index cladding region (3) correspond to the mid-points of transition regions 40 and 42, respectively. The mid-points correspond to half of the depth 44 of the depressed-index cladding region (3).

The relative ordering of relative refractive indices Δ₁, Δ₂, Δ₃, and Δ₄ in the relative refractive index profile shown in FIGS. 10 and 11 satisfy the conditions Δ₁ₘₐₓ>Δ₄>Δ₃ and Δ₁ₘₐₓ>Δ₂>Δ₃. The values of Δ₂ and Δ₄ may be equal or either may be greater than the other, but both Δ₂ and Δ₄ are between Δ₁ₘₐₓ and Δ₃.

The relative refractive indices Δ₁, Δ₂, Δ₃, and Δ₄ are based on the materials used in the core region, inner cladding region, depressed-index cladding region, and outer cladding region. A description of these material with regard to the relative refractive indices Δ₁, Δ₂, Δ₃, and Δ₄ is provided below.

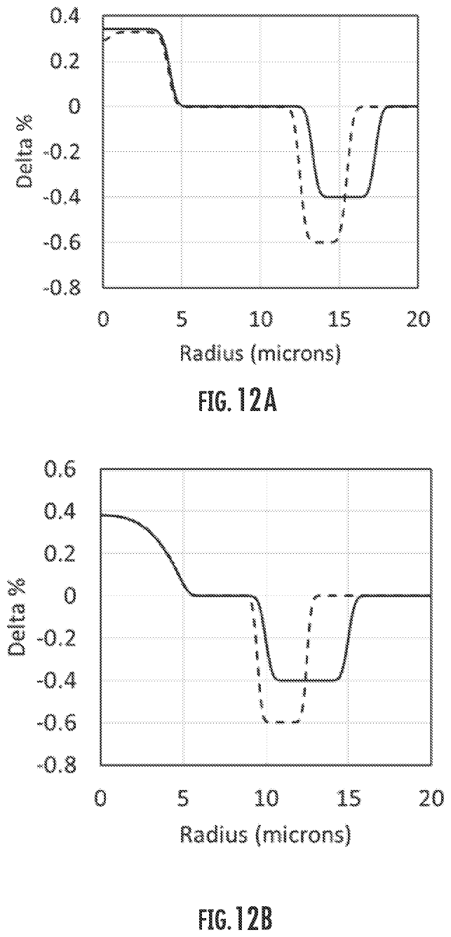

FIG. 12A illustrates the refractive index profiles of two embodiments comprising a core having a rounded step-index with a maximum refractive index delta between 0.3 and 0.38%, an inner cladding having a relative refractive index delta between about −0.05 and 0.05%, and a depressed outer cladding, or trench, having a relative refractive index delta between about −0.3% and −0.7%. In these embodiments, the radius of the core is between 4.0 and 5.0 microns, the width of the inner cladding is between 6.0 and 10.0 microns, and the width of the trench is between 2.0 and 8.0 microns. The volume of the trench is less than −30%-sq. microns, or between about-30 and −70%-sq. microns, or between about-30 and −60%-sq. microns, or between about-40 and −60%-sq. microns.

FIG. 12B illustrates the refractive index profiles of two embodiments which comprise a graded-index core having an alpha value less than 8 and a maximum refractive index delta between 0.36 and 0.42%, an inner cladding having a relative refractive index delta between about −0.05 and 0.05%, and a depressed outer cladding, or trench, having a relative refractive index delta between about −0.3% and −0.7%. In these embodiments with graded-index cores, the radius of the core is between 4.8 and 5.8 microns, the width of the inner cladding is between 6.0 and 10.0 microns, and the width of the trench is between 2.0 and 8.0 microns. The volume of the trench is less than −30%-sq. microns, or between about-30 and −70%-sq. microns, or between about-30 and −60%-sq. microns, or between about-40 and −60%-sq. microns.

The table below provides the parameters and modeled optical properties of the waveguides having the refractive index profiles illustrated in FIGS. 12A and 12B.

TABLE 1
Optical Fiber Profile Designs for Examples 1-6

| | Example 1 | Example 2 | Example 3 | Example 4 | Example 5 | Example 6 |
|---|---|---|---|---|---|---|
| Delta0 | 0 | 0.28 | 0.35 | 0 | 0 | 0 |
| (%) | | | | | | |
| R0 | 0 | 1 | 0 | 0 | 0 | 0 |
| (microns) | | | | | | |
| Delta1 | 0.34 | 0.33 | 0.35 | 0.38 | 0.37 | 0.37 |
| (%) | | | | | | |
| R1 | 4.4 | 4.3 | 4.3 | 5.3 | 5.5 | 5.2 |
| (microns) | | | | | | |
| Alpha | 20 | 20 | 12 | 2.8 | 2.8 | 4.0 |
| Delta2 | 0 | 0 | 0 | 0 | 0 | 0 |
| (%) | | | | | | |
| R2 | 13.3 | 12.5 | 12.5 | 10.0 | 9.7 | 10.2 |
| (microns) | | | | | | |
| W2 | 8.9 | 8.2 | 8.2 | 4.7 | 4.2 | 5 |
| (R2 − R1, microns) | | | | | | |
| Delta3 | −0.4 | −0.6 | −0.36 | −0.4 | −0.6 | −0.45 |
| (microns) | | | | | | |
| R3 | 17.3 | 15.5 | 17.5 | 15 | 12.7 | 15.2 |
| (microns) | | | | | | |
| W3 | 4.0 | 3.0 | 5.0 | 5.0 | 3.0 | 5.0 |
| (R3 − R2, microns) | | | | | | |
| V3 | −49.0 | −50.4 | −54.0 | −50.0 | −40.3 | −57.2 |
| (%-sq. microns) | | | | | | |
| Delta4 | 0 | 0 | 0 | 0 | 0 | 0 |
| (microns) | | | | | | |
| Cladding Radius R4 | 50 | 50 | 50 | 50 | 50 | 50 |
| (microns) | | | | | | |
| Inner Coating Radius | 60 | 62.5 | 62.5 | 62.5 | 65 | 62.5 |
| R5 | | | | | | |
| (microns) | | | | | | |
| Outer Coating Radius | 75 | 82.5 | 80 | 77.5 | 82.5 | 82.5 |
| R6 | | | | | | |
| (microns) | | | | | | |
| MFD at 1310 nm | 9.13 | 9.19 | 8.95 | 9.04 | 9.18 | 9.09 |
| (microns) | | | | | | |
| MFD at 1550 nm | 10.36 | 10.44 | 10.18 | 10.18 | 10.23 | 10.17 |
| (microns) | | | | | | |
| Aeff at 1310 nm | 65.4 | 66.0 | 62.5 | 62.7 | 65.0 | 64.1 |
| (sq. microns) | | | | | | |
| Aeff at 1550 nm | 82.0 | 83.1 | 78.8 | 78.5 | 80.0 | 79.0 |
| (sq. microns) | | | | | | |
| Dispersion at 1310 | 0.02 | −0.13 | −0.35 | 0.06 | 0.82 | 0.67 |
| nm | | | | | | |
| (ps/nm/km) | | | | | | |
| Dispersion at 1550 | 17.18 | 17.34 | 16.85 | 18.34 | 19.50 | 18.75 |
| nm | | | | | | |
| (ps/nm/km) | | | | | | |
| Dispersion Slope at | 0.087 | 0.088 | 0.09 | 0.092 | 0.093 | 0.09 |
| 1310 nm | | | | | | |
| (ps/nm\hat{ }2/km) | | | | | | |
| Zero Dispersion | 1309.8 | 1311.5 | 1314.0 | 1309.3 | 1301.2 | 1302.7 |
| Wavelength | | | | | | |
| (nm) | | | | | | |
| Cable Cutoff | 1220 | 1195 | 1210 | 1200 | 1190 | 1240 |
| Wavelength | | | | | | |
| (nm) | | | | | | |
| 1 × 15 mm macrobend | 0.05 | 0.09 | 0.05 | 0.05 | 0.05 | 0.03 |
| loss | | | | | | |
| (dB/turn) | | | | | | |

In these embodiments, the MFD at 1310 nm is between 8.6 and 9.5 microns, or between 8.7 and 9.3 microns, or between 9.0 and 9.4 microns. The zero dispersion wavelength is between 1300 and 1324 nm. The cable cutoff wavelength is less than 1260 nm and is less than 1240 nm or 1220 nm in some embodiments.

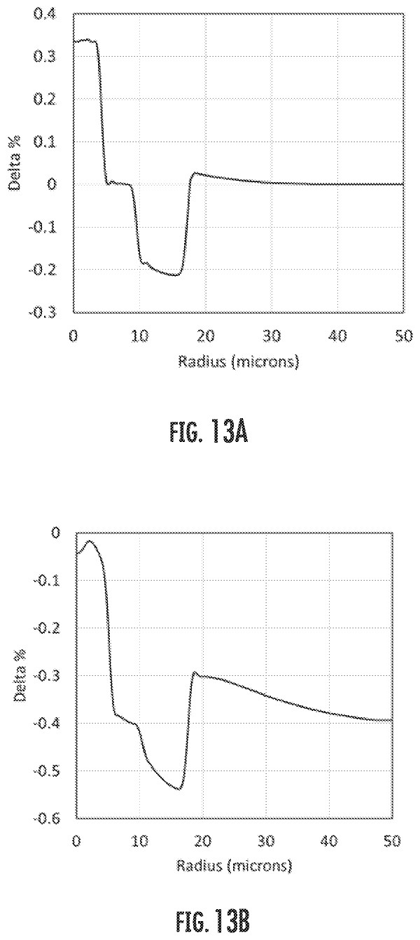

FIG. 13A illustrates the refractive index profile of a manufactured optical fiber comprising a chlorine-doped core and a fluorine-doped cladding. The maximum refractive index delta is about 0.34%, the inner cladding has a relative refractive index delta of about 0%, and the depressed outer cladding, or trench, has a relative refractive index delta of about −0.21%. In this embodiment, the radius of the core is about 5 microns, the width of the inner cladding is about 4.6 microns, and the width of the trench is about 7.6 microns. The volume of the trench is −42.8%-sq. microns.

FIG. 13B illustrates the refractive index profile of another manufactured optical fiber comprising an alkali-doped core and a fluorine-doped cladding. The maximum refractive index delta is −0.02%, the inner cladding has a relative refractive index delta of −0.39%, and the depressed outer cladding, or trench, has a relative refractive index delta of −0.52%. In this embodiment, the radius of the core is about 5.8 microns, the width of the inner cladding is about 3.8 microns, and the width of the trench is about 8.0 microns. The volume of the trench is about −25.0%-sq. microns.

The table below provides the parameters and modeled optical properties of the waveguides having the refractive index profiles illustrated in FIGS. 13A and 13B.

TABLE 2
Optical Fiber Profile Designs for Examples 7 and 8

| | Example 7 | Example 8 |
|---|---|---|
| Delta0 (%) | 0.335 | −0.04 |
| R0 (microns) | 0.5 | 2.5 |
| Delta1 (%) | 0.34 | −0.02 |
| R1 (microns) | 5 | 5.8 |
| Alpha | 20 | 1.5 |
| Delta2 (%) | 0 | −0.39 |
| R2 (microns) | 9.6 | 9.6 |
| W2 (R2 − R1, microns) | 4.6 | 3.8 |
| Delta3 (microns) | −0.21 | −0.52 |
| R3 (microns) | 17.2 | 17.6 |
| W3 (R3 − R2, microns) | 7.6 | 8.0 |
| V3 (%-sq. microns) | −42.8 | −25.0 |
| Delta4 (microns) | 0 | −0.39 |
| Cladding Radius R4 (microns) | 50 | 50 |
| Inner Coating Radius R5 | 65 | 65 |
| (microns) | | |
| Outer Coating Radius R6 | 83 | 79 |
| (microns) | | |
| MFD at 1310 nm (microns) | 9.28 | 9.65 |
| MFD at 1550 nm (microns) | 10.38 | 10.63 |
| Aeff at 1310 nm (sq. microns) | 66.9 | 71.4 |
| Aeff at 1550 nm (sq. microns) | 82.5 | 88.9 |
| Dispersion at 1310 nm | 0.68 | 1.63 |
| (ps/nm/km) | | |
| Dispersion at 1550 nm | 18.49 | 19.22 |
| (ps/nm/km) | | |
| Dispersion Slope at 1310 nm | 0.09 | 0.09 |
| (ps/nm\hat{ }2/km) | | |
| Zero Dispersion Wavelength | 1302.4 | 1292.0 |
| (nm) | | |
| Cable Cutoff Wavelength (nm) | 1203 | 1243 |
| 1 × 15 mm macrobend loss | 0.07 | 0.33 |
| (dB/turn) | | |

In these embodiments, the MFD at 1310 nm are 9.28 microns and 9.65 microns for Examples 7 and 8, respectively. The zero dispersion wavelength is 1302.4 nm for Example 7 and 1292.0 nm for Example 8. The cable cutoff wavelength is 1203 nm for Example 7 and 1243 nm for Example 8.

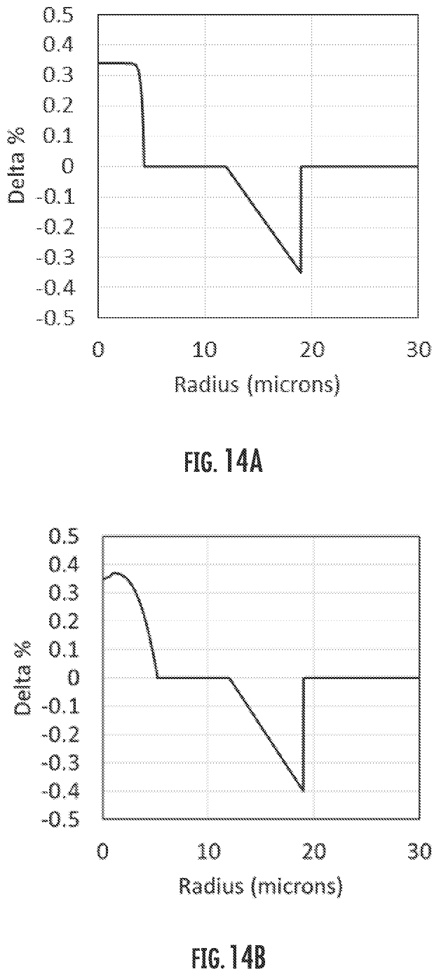

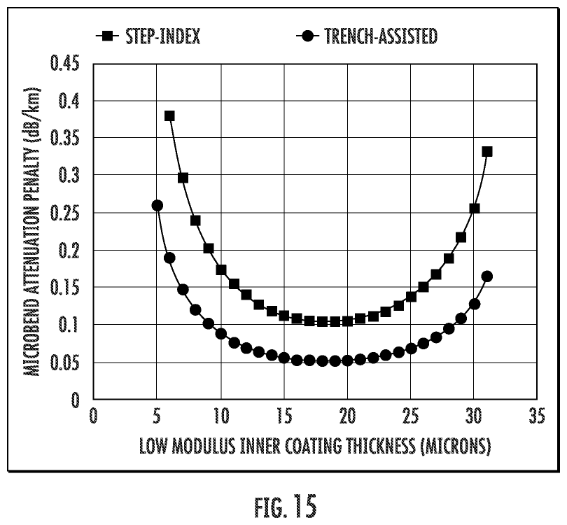

FIG. 14A illustrates a refractive index profile representative of embodiments of an optical fiber comprising a core having a rounded step-index with a triangular sloped trench (Examples 10 and 11). In these embodiments, the maximum refractive index delta is about 0.35% and 0.34% for Examples 10 and 11, respectively, the inner cladding has a relative refractive index delta of about 0 for both Examples 10 and 11, and a depressed outer cladding, or trench, has a relative refractive index delta of about −0.35% for both Examples 10 and 11. In these embodiments, the radius of the core is about 5.2 microns and 4.35 microns for Examples 10 and 11, respectively, the width of the inner cladding is 6.8 microns and 7.65 microns for Examples 10 and 11, respectively, and the width of the trench is 7 microns for both Examples 10 and 11. The volume of the trench is about −41%-sq. microns for both Examples 10 and 11.

FIG. 14B illustrates a refractive index profile representative of an optical fiber comprising a core having a graded-index and a triangular sloped trench (Examples 9 and 12). In these embodiments, the maximum refractive index delta is about 0.37% and 0.34% for Examples 9 and 12, respectively, the inner cladding has a relative refractive index delta of about 0 for both Examples 9 and 12, and a depressed outer cladding, or trench, has a relative refractive index delta of about −0.4% and −0.45 for Examples 9 and 12, respectively. In these embodiments, the radius of the core is about 5.2 microns and 4.4 microns for Examples 9 and 12, respectively, the width of the inner cladding is 6.8 microns and 8.6 microns for Examples 9 and 12, respectively, and the width of the trench is 7 microns and 6 microns for Examples 9 and 12, respectively. The volume of the trench is about −46.9%-sq. microns and −46.1%-sq. microns for both Examples 9 and 12.

The table below provides the parameters and modeled optical properties of the waveguides having the refractive index profiles illustrated in FIGS. 14A and 14B.

TABLE 3
Optical Fiber Profile Designs for Examples 9-12

| | Example | Example | Example | Example |
|---|---|---|---|---|
| | 9 | 10 | 11 | 12 |
| Delta0 (%) | 0.35 | 0.35 | 0.34 | 0.31 |
| R0 (microns) | 1 | 0 | 0 | 1 |
| Delta1 (%) | 0.37 | 0.35 | 0.34 | 0.34 |
| R1 (microns) | 5.2 | 5.2 | 4.35 | 4.4 |
| Alpha | 2.5 | 4 | 20 | 12 |
| Delta2 (%) | 0 | 0 | 0 | 0 |
| R2 (microns) | 12 | 12 | 12 | 13 |
| W2 (R2 − R1, microns) | 6.8 | 6.8 | 7.65 | 8.6 |
| Delta3 Min (microns) | −0.4 | −0.35 | −0.35 | −0.45 |
| R3 (microns) | 19 | 19 | 19 | 19 |
| W3 (R3 − R2, microns) | 7 | 7 | 7 | 6 |
| V3 (%-sq. microns) | −46.9 | −41 | −41 | −46.1 |
| Delta4 (microns) | 0 | 0 | 0 | 0 |
| Cladding Radius R4 | 50 | 50 | 50 | 50 |
| (microns) | | | | |
| Inner Coating Radius R5 | 62.5 | 62.5 | 62.5 | 62.5 |
| (microns) | | | | |
| Outer Coating Radius R6 | 82.5 | 82.5 | 82.5 | 82.5 |
| (microns) | | | | |
| MFD at 1310 nm | 9.08 | 9.30 | 9.08 | 9.11 |
| (microns) | | | | |
| MFD at 1550 nm | 10.36 | 10.57 | 10.32 | 10.37 |
| (microns) | | | | |
| Aeff at 1310 nm (sq. | 63.4 | 66.8 | 64.8 | 65.4 |
| microns) | | | | |
| Aeff at 1550 nm (sq. | 80.8 | 84.4 | 81.4 | 82.2 |
| microns) | | | | |
| Dispersion at 1310 nm | −0.47 | −0.04 | −0.09 | −0.10 |
| (ps/nm/km) | | | | |
| Dispersion at 1550 nm | 16.76 | 17.20 | 16.80 | 16.76 |
| (ps/nm/km) | | | | |
| Dispersion Slope at 1310 | 0.088 | 0.088 | 0.086 | 0.086 |
| nm (ps/nm\hat{ }2/km) | | | | |
| Zero Dispersion | 1315.4 | 1310.5 | 1311.0 | 1311.2 |
| Wavelength (nm) | | | | |
| Cable Cutoff Wavelength | 1220 | 1220 | 1220 | 1210 |
| (nm) | | | | |
| 1 × 15 mm macrobend | 0.15 | 0.19 | 0.19 | 0.20 |
| loss (dB/turn) | | | | |

In these embodiments, the MFD at 1310 nm are 9.08 microns, 9.30 microns, 9.08 microns, and 9.11 microns for Examples 9-12, respectively. The zero dispersion wavelength is 1315.4 nm, 1310.5 nm 1311.0 nm, and 1311.2 nm for Examples 9-12, respectively. The cable cutoff wavelength is 1220 nm, 1220 nm, 1220 nm, and 1210 nm for Examples 9-12, respectively.

### Core Region

The core region comprises silica glass. The silica glass of the core region may be undoped silica glass, updoped silica glass, and/or downdoped silica glass. Updoped silica glass includes silica glass doped with an alkali metal oxide (e.g. Na₂O, K₂O, Li₂O, Cs₂O, or Rb₂O). Downdoped silica glass includes silica glass doped with F. In one embodiment, the silica glass of the core region may be Ge-free and/or Cl-free; that is the core region comprises silica glass that lacks Ge and/or Cl.

Additionally, or alternatively, the core region may comprise silica glass doped with at least one alkali metal, such as, lithium (Li), sodium (Na), potassium (K), rubidium (Rb), cesium (Cs) and/or francium (Fr). In some embodiments, the silica glass is doped with a combination of sodium, potassium, and rubidium. The silica glass may have a peak alkali concentration in the range from about 10 ppm to about 500, or in the range from about 20 ppm to about 450 ppm, or in the range from about 50 ppm to about 300 ppm, or in the range from about 10 ppm to about 200 ppm, or in the range from about 10 ppm to about 150 ppm. The alkali metal doping within the disclosed ranges results in lowering of Rayleigh scattering, thereby proving a lower optical fiber attenuation.

In some embodiments, the core region comprises silica glass doped with an alkali metal and doped with F as a downdopant. The concentration of F in the core of the fiber is in the range from about 0.1 wt % to about 2.5 wt %, or in the range from about 0.25 wt % to about 2.25 wt %, or in the range from about 0.3 wt % to about 2.0 wt %.

In other embodiments, the core region comprises silica glass doped with Ge and/or Cl. The concentration of GeO₂ in the core of the fiber may be in a range from about 2.0 to about 8.0 wt %, or in a range from about 3.0 to about 7.0 wt %, or in a range from about 4.0 to about 6.5 wt. %. The concentration of Cl in the core of the fiber may be in a range from 1.0 wt % to 6.0 wt %, or in a range from 1.2 wt % to 5.5 wt %, or in a range from 1.5 wt % to 5.0 wt %, or in a range from 2.0 wt % to 4.5 wt %, or greater than or equal to 1.5 wt % (e.g., ≥2 wt %, ≥2.5 wt %, ≥3 wt %, ≥3.5 wt %, ≥4 wt %, ≥4.5 wt %, ≥5 wt %, etc.).

In embodiments where the core is substantially free of Ge or Cl, the relative refractive index Δ₁ or Δ₁ₘₐₓ of the core region is in the range from about −0.10% to about 0.20%, or in the range from about −0.05% to about 0.15%, or in the range from about 0.0% to about 0.10%. The minimum relative refractive index Δ₁ₘᵢₙ of the core is in the range from about −0.20% to about −0.50%, or in the range from about −0.30% to about −0.40%, or in the range from about −0.32% to about −0.37%. The difference Δ₁ₘₐₓ to Δ₁ₘᵢₙ is greater than 0.05%, or greater than 0.10%, or greater than 0.15%, or greater than 0.20%, or in the range from 0.05% to 0.40%, or in the range from 0.10% to 0.35%.

In embodiments where the core is doped with Ge and/or Cl, the relative refractive index Δ₁ or Δ₁ₘₐₓ of the core region is in the range from about 0.20% to about 0.45%, or in the range from about 0.25% to about 0.40%, or in the range from about 0.30% to about 0.38%. The minimum relative refractive index Δ₁ₘᵢₙ of the core is in the range from about −0.05% to about −0.05%, or in the range from about −0.03% to about 0.03%, or in the range from about −0.02% to about 0.02%. The difference Δ₁ₘₐₓ to Δ₁ₘᵢₙ is greater than 0.20%, or greater than 0.25%, or greater than 0.30%, or in the range from 0.25% to 0.45%, or in the range from 0.30% to 0.40%.

The radius r₁ of the core region is in the range from about from about 3.0 microns to about 6.5 microns, or in the range from about 3.5 microns to about 6.0 microns, or in the range from about 4.0 microns to about 6.0 microns, or in the range from about 4.5 microns to about 5.5 microns. In some embodiments, the core region includes a portion with a constant or approximately constant relative refractive index that has a width in the radial direction of at least 1.0 micron, or at least 2.0 microns, or at least 3.0 microns, or in the range from 1.0 microns to 3.0 microns, or in the range from 2.0 microns to 3.0 microns. In some embodiments, the portion of the core region having a constant or approximately constant relative refractive index has a relative refractive index of Δ₁ₘᵢₙ.

### Inner Cladding Region

In embodiments in which the core is substantially free of Ge and Cl, the inner cladding region is comprised of downdoped silica glass that is doped with F. The average concentration of downdopant in the inner cladding region is greater than the average concentration of downdopant in the core region.

The relative refractive index Δ₂ or Δ₂ₘₐₓ of the inner cladding region is in the range from about −0.20% to about −0.50%, or in the range from about −0.25% to about −0.45%, or in the range from about −0.30% to about −0.40%, or in the range from about −0.33% to about −0.37%. The relative refractive index Δ₂ is preferably constant or approximately constant. The difference Δ₁ₘₐₓ−Δ₂ (or the difference Δ₁ₘₐₓ−Δ₂ₘₐₓ) is greater than about 0.25%, or greater than about 0.30%, or greater than about 0.35%, or in the range from about 0.25% to about 0.45%, or in the range from about 0.30% to about 0.40%.

The radius r₂ of the inner cladding region is in the range from about 7.0 microns to about 15.0 microns, or in the range from about 7.5 microns to about 13.0 microns, or in the range from about 8.0 microns to about 12.0 microns, or in the range from about 8.5 microns to about 11.5 microns, or in the range from about 9.0 microns to about 11.0 microns, or in the range from about 9.5 microns to about 10.5 microns. The thickness r₂−r₁ of the inner cladding region is in the range from about 3.0 microns to about 10.0 microns, or from about 4.0 microns to about 9.0 microns, or from about 4.5 microns to about 7.0 microns.

In embodiments in which the core is doped with Ge and/or Cl, the inner cladding region comprises silica that is substantially free of Ge and/or Cl. The relative refractive index Δ₂ or Δ₂ₘₐₓ of the inner cladding region is in the range from about −0.05% to about −0.05%, or in the range from about −0.03% to about 0.03%, or in the range from about −0.02% to about 0.02%. The relative refractive index Δ₂ is preferably constant or approximately constant. The difference Δ₁ₘₐₓ−Δ₂ (or the difference Δ₁ₘₐₓ−Δ₂ₘₐₓ) is greater than about 0.20%, or greater than about 0.25%, or greater than about 0.30%, or in the range from about 0.25% to about 0.40%, or in the range from about 0.30% to about 0.38%.

The radius r₂ of the inner cladding region is in the range from about 8.0 microns to about 16.0 microns, or in the range from about 9.0 microns to about 15.0 microns, or in the range from about 10.0 microns to about 14.0 microns, or in the range from about 10.5 microns to about 13.5 microns, or in the range from about 11.0 microns to about 13.0 microns. The thickness r₂−r₁ of the inner cladding region is in the range from about 3.0 microns to about 10.0 microns, or from about 4.0 microns to about 9.0 microns, or from about 5.0 microns to about 8.0 microns.

### Depressed-Index Cladding Region

The depressed-index cladding region comprises downdoped silica glass. As discussed above, the preferred downdopant is fluorine. The concentration of fluorine in the depressed-index cladding region is in the range from about 0.30 wt % to about 2.50 wt %, or in the range from about 0.60 wt % to about 2.25 wt %, or in the range from about 0.90 wt % to about 2.00 wt %.

The relative refractive index 43 or 43 min is in the range from about −0.30% to about −0.80%, or in the range from about −0.40% to about −0.70%, or in the range from about −0.50% to about −0.65%. The relative refractive index Δ₃ is preferably constant or approximately constant. The difference Δ₁ₘₐₓ−Δ₃ (or the difference Δ₁ₘₐₓ−Δ₃ min, or the difference Δ₁−Δ₃, or the difference Δ₁−Δ₃ₘᵢₙ) is greater than about 0.50%, or greater than about 0.55%, or greater than about 0.6%, or in the range from about 0.50% to about 0.80%, or in the range from about 0.55% to about 0.75%. The difference Δ₂−Δ₃ (or the difference Δ₂−Δ₃ₘᵢₙ, or the difference Δ₂ₘₐₓ−Δ₃, or the difference Δ₂ₘₐₓ−Δ₃ min) is greater than about 0.10%, or greater than about 0.20%, or greater than about 0.30%, or in the range from about 0.10% to about 0.70%, or in the range from about 0.20% to about 0.65%.

The inner radius of the depressed-index cladding region is r₂ and has the values specified above. The outer radius r₃ of the depressed-index cladding region is in the range from about 10.0 microns to 20.0 microns, or in the range from about 12.0 microns to about 19.5 microns, or in the range from about 13.0 microns to about 19.0 microns, or in the range from about 13.5 microns to about 18.5 microns, or in the range from about 14.0 microns to about 18.0 microns, or in the range from about 14.5 microns to about 17.5 microns. The thickness r₃−r₂ of the depressed-index cladding region is in the range from 1.0 microns to 12.0 microns, or in the range from about 2.0 microns to about 10.0 microns, or in the range from about 2.5 microns to about 9.0 microns, or in the range from about 3.0 microns to about 8.0 microns.

The depressed-index cladding region may be an offset trench design with a trench volume of about 20% Δ-micron² or greater, or about 30% Δ-micron² or greater or about 50% Δ-micron² or greater, or about 75% Δ-micron² or less, or about 20% Δ-micron² or greater and about 75% Δ-micron² or less, or about 30% Δ-micron² or greater and about 75% Δ-micron² or less. Trench volumes lower than the disclosed ranges have reduced bending performance, and trench volumes higher than the disclosed ranges no longer operate as single-mode fibers.

The offset trench designs disclosed herein include an inner cladding region. Furthermore, the offset trench designs disclosed herein provide advantages over traditional trench designs that are adjacent to the core region. More specifically, the offset trench designs disclosed herein reduce confinement of the fundamental mode and provide improved bend loss at large bend diameters (e.g., bend diameters >25 mm) for target optical fiber mode field diameter and cable cutoff characteristics. Furthermore, the trench designs disclosed herein have a depressed index trench region, which advantageously confines the intensity profile of the fundamental LP01 mode propagating through the optical fiber, thereby reducing the optical fiber mode field diameter.

### Outer Cladding Region

In embodiments in which the core is substantially free of Ge and Cl, the outer cladding region comprises downdoped silica glass. The preferred downdopant is fluorine. The concentration of fluorine in the outer cladding region is in the range from about 0.30 wt % to about 2.20 wt %, or in the range from about 0.60 wt % to about 2.00 wt %, or in the range from about 0.90 wt % to about 1.80 wt %. The relative refractive index Δ₄ or Δ₄ₘₐₓ of the outer cladding region is in the range from about −0.20% to about −0.50%, or in the range from about −0.25% to about −0.45%, or in the range from about −0.30% to about −0.40%, or in the range from about −0.33% to about 0.37%. The relative refractive index Δ₄ is preferably constant or approximately constant. As shown in FIG. 10, the relative refractive index Δ₄ may be approximately equal to the relative refractive index Δ₂.

In an embodiment, the outer cladding is substantially pure silica. Alternatively, the outer cladding may be doped with Cl to a relative refractive index in the range from about 0.01% to about 0.1%, or from about 0.02% to about 0.08%, or from about 0.03% to about 0.06%. The concentration of Cl in the outer cladding may range from about 0.1 wt % to about 1.0 wt %, from about 0.2 wt % to about 0.8 wt %, or from about 0.3 wt % to about 0.6 wt %. Alternatively, the outer cladding may be doped with Titania to strengthen the cladding surface so as to stop defects such as scratches from propagating through the fiber. In some embodiments, the outer cladding may be doped with a Titania concentration of about 5 wt % to about 25 wt %.

The inner radius of the outer cladding region is r₃ and has the values specified above. In some embodiments, the outer radius r₄ is about 50 microns which allows the thickness of the low-modulus and high-modulus coatings to be increased. The outer radius r₄ of the outer cladding region is in the range from 45 microns to 55 microns, or in the range from 46 microns to 54 microns, or in the range from 47 microns to 53 microns, or in the range from 48 microns to 52 microns, or in the range from 49 microns to 51 microns, or in the range from 49.5 microns to 50.5 microns. Thus, for example, the diameter of the cladding region (i.e., outer radius r₄ multiplied by 2) in the range from 90 microns to 110 microns, or in the range from 92 microns to 108 microns, or in the range from 94 microns to 106 microns, or in the range from 96 microns to 104 microns, or in the range from 98 microns to 102 microns, or in the range from 99 microns to 101 microns, or in the range from 99.3 microns to 100.7 microns, or in the range from 99.5 microns to 100.5 microns. The thickness r₄−r₃ of the outer cladding region is in the range from about 20.0 microns to about 60.0 microns, or in the range from about 30.0 microns to about 55.0 microns, or in the range from about 40.0 microns to about 50.0 microns.

### Optical Fiber Characteristics

The optical fibers according to the embodiments of the present disclosure may have a mode field diameter at 1310 nm in the range of about 8.6 microns to about 10.0 microns, in the range of about 8.8 microns to about 9.8 microns, or in the range of about 9.0 microns to about 9.5 microns. In embodiments, the mode field diameter at 1550 nm is in the range of about 9.6 microns to about 11.0 microns, in the range of about 9.8 microns to about 10.8 microns, or in the range of about 10.0 microns to about 10.5 microns. In some embodiments, the 22-meter cable cutoff wavelength is less than about 1500 nm, or less than about 1450 nm, or less than about 1400 nm, or less than about 1300 nm, or less than about 1260 nm. In some embodiments, the 2-meter fiber cutoff wavelength is less than about 1520 nm, or less than about 1500 nm, or less than about 1450 nm, or less than about 1400 nm, less than about 1300 nm, or less than about 1260 nm.

Additionally, optical fibers according to the embodiments of the present disclosure may have an effective area at 1550 nm greater than about 70.0 micron², greater than about 75.0 micron², greater than about 80 micron², or greater than about 85 micron², or in the range of about 75 micron² to about 95 micron², or in the range from about 80 micron² to about 90 micron², or about 85 micron² to about 90 micron².

The attenuation of the optical fibers disclosed herein is less than or equal to 0.36 dB/km at a wavelength of 1310 nm, or less than or equal to 0.35 dB/km, or less than or equal to 0.34 dB/km, or less than or equal to 0.32 dB/km at a wavelength of 1310 nm. The attenuation of the optical fibers disclosed herein is less than or equal to 0.24 dB/km, or less than or equal to 0.22 dB/km, or less than or equal to 0.20 dB/km, or less than or equal to 0.19 dB/km at a wavelength of 1550 nm.

The off-set trench design of optical fibers 60, 64, and 65 provide improved bend performance for the smaller diameter fibers disclosed herein. More specifically, the off-set trench design disclosed herein provides low attenuation, large effective area, and low bend loss in a compact form, with a cladding diameter of about 100 microns and an outer coating diameter less than 170 microns.

### Coating Properties

The transmissivity of light through an optical fiber is highly dependent on the properties of the coatings applied to the glass fiber. As discussed above (and with reference to FIG. 7), the coatings may include a low-modulus inner coating 22 and a high-modulus coating 24, where the high-modulus coating surrounds the optional low-modulus inner coating and the low-modulus inner coating contacts the glass fiber (which includes a central core region surrounded by a cladding region). An optional pigmented outer coating layer 26 (e.g. ink layer) surrounds and directly contacts the high-modulus coating.

High-modulus coating 24 is a harder material (higher Young's modulus) than the low-modulus coating 22 and is designed to protect the glass fiber from damage caused by abrasion or external forces that arise during processing, handling, and deployment of the optical fiber. Low-modulus inner coating 22 is a softer material (lower Young's modulus) than high-modulus coating 24 and is designed to buffer or dissipates stresses that result from forces applied to the outer surface of the high-modulus coating. The low-modulus coating may help dissipate stresses that arise due to the microbends the optical fiber encounters when deployed in a cable but is not essential for short length applications such as optical interconnects. The microbending stresses transmitted to the glass fiber need to be minimized because microbending stresses create local perturbations in the refractive index profile of the glass fiber. The local refractive index perturbations lead to intensity losses for the light transmitted through the glass fiber. By dissipating stresses, the optional low-modulus coating minimizes intensity losses caused by microbending.

A thinner coating on the optical fiber is considered to increase microbending loss because it provides less protection against external perturbations. These perturbations result in power coupling from the light guided in the core (core mode) to higher-order modes in the cladding (cladding mode). As shown in FIG. 13, the cladding mode can have significant overlap with the coating layer which has high absorption. This process of coupling and absorption by the coating materials result in optical power loss.

An approach for quantifying the microbending loss of an optical fiber on the properties of the coatings is published in the article entitled “Relationship of Mechanical Characteristics of Dual Coated Single Mode Fibers and Microbending Loss,” by J. Baldauf, N. Okada and M. Miyamoto, in IEICE Trans. Commun., Vol. E76-B, No. 4, pp. 352-357 (April, 1993). The authors introduced a parameter χₛ, which is an effective spring constant for the force that couples the secondary (high-modulus) coating and the glass fiber. This spring constant parameterization provides qualitative guidance that a thick primary (low-modulus) coating with a low modulus provides better microbending performance, but it does not fully capture the contributions of the refractive index profile and the high-modulus coating.

The combined roles of the glass, low-modulus inner coating, and high-modulus coating result in a microbending attenuation penalty (MAP) of:

$$M A P = {C}_{0} {f}_{0} σ \frac{{f}_{RIP} {f}_{g} ( {E}_{g} , {R}_{g} ) {f}_{p} ( {E}_{p} , {t}_{p} )}{{f}_{cs} ( \frac{{E}_{s}}{{E}_{p}} , {R}_{s} , {t}_{s} )} \qquad ( 8 )$$

where f₀ and σ are the average lateral pressure and standard deviation of the roughness of the external surface in contact with the high-modulus coating, respectively, and

$${C}_{0} = 4 \times {{10}^{25} [ {( \frac{π}{4} )}^{2.625} ]}^{- 1} .$$

f_{RIP} accounts for the role of the refractive index profile and is of order unity. Attenuation data indicates that f_{RIP} is approximately 1.0 for single-mode fiber with a step-index refractive index profile and is about 0.5 for bend-insensitive single-mode fibers with refractive index profiles such as those shown in FIGS. 10 and 11. The other three terms in Eq. 8 are the contributions of the glass, low-modulus inner coating and the system comprising the low-modulus inner coating and high-modulus coating to the microbending response and are given by:

$${f}_{g} = \frac{1}{{E}_{g}^{2} {R}_{g}^{6}} ,$$

$${f}_{p} = \frac{{E}_{p}}{{t}_{p}^{2}} ,$$

$$and {f}_{cs} = {[ 1 + \frac{{E}_{s}}{{E}_{p}} {( \frac{{t}_{s}}{{R}_{s}} )}^{3} ]}^{0.375} {\{ \frac{{E}_{s}}{{E}_{p}} [ {R}_{s}^{4} - {( {R}_{s} - {t}_{s} )}^{4} ] \}}^{0.625} ,$$

where R_{g} is the radius of the glass (i.e. the outer radius of the outer cladding region), Rₛ is the outer radius of the high-modulus outer coating, tₚ is the thickness of the inner low-modulus coating, tₛ is the thickness of the high-modulus outer coating, and E_{g}, Eₚ and Eₛ are the elastic moduli of the glass, low-modulus inner coating and high-modulus coating, respectively. The MAP has units of dB/km when the units for the moduli and radii are GPa and microns, respectively. The f_{cs} coating system coefficient is of interest for fibers with thinner coatings because it is very large when the high-modulus coating is relative thick (tₛ is greater than about 20 microns), which corresponds to a low MAP. However, it becomes quite small and yields a MAP value greater than 0.01 dB/km when the high-modulus coating thickness tₛ is less than about 10 microns, which is a consequence of a decrease in the rigidity of the outer coating. The fiber attenuation in the absence of any microbending attenuation penalty is assumed to be approximately 0.19 dB·km, so the net attenuation of the coated optical fiber system is 0.19 dB/km plus the microbend attenuation penalty.

As used herein the term “puncture load” refers to the amount force impinging on the coating of the fiber described herein. As used herein the term “puncture resistance” refers to the force from the fiber coating opposing the puncture load. As described further below, the coating will rupture when the puncture load exceeds the maximum puncture resistance of the coating. With respect to puncture resistance, the analysis by Glaesemann and Clark in the article “Quantifying the Puncture Resistance of Optical Fiber Coatings,” Proc. 52nd IWCS, pp. 237-245 (1993) for fibers with one type of coating indicated that the puncture resistance has a linear dependence on the cross-sectional area Aₛ of the high-modulus coating. The analysis in this paper hypothesized that the puncture resistance was due to hoop stress on the high-modulus coating, which they modeled as a thin cylinder that is subjected to internal pressure from the low-modulus inner coating. However, for most optical fibers, the ratio of the thickness tₛ of the high-modulus coating to the outer radius r₆ of is on the order of 10%, so the low-modulus coating of the fiber can be approximated as a thick-walled cylinder with pressure Pₒ acting from the outside and exerting a puncture load. In the limit where the external pressure is much greater than the internal pressure from the low-modulus inner coating, the maximum hoop stress is

$${σ}_{θ} = \frac{- 2 {R}_{s}^{2} {P}_{o}}{( {R}_{s}^{2} - {R}_{p}^{2} )} = \frac{- 2 π {R}_{s}^{2} {P}_{o}}{{A}_{s}} ,$$

where A_{S} is the cross-sectional area of the high-modulus coating. This hoop stress has the observed inverse dependence on A_{S}, and the puncture resistance is then P_{R}=P₀+C₁EₛAₛ, where Es is the modulus of the high-modulus coating, and coefficients P₀ and C₁ have values of about 11.3 g and 2.1 g/MPa/mm², respectively.

### Coating Examples Preparation and Measurement Techniques

The properties of the optional low-modulus inner coating and high-modulus coating, as disclosed herein, were determined using the measurement techniques described below:

Tensile Properties. The curable high-modulus coating compositions were cured and configured in the form of cured rod samples for measurement of Young's modulus, tensile strength at yield, yield strength, and elongation at yield. The cured rods were prepared by injecting the curable high-modulus coating composition into Teflon® tubing having an inner diameter of about 0.025″. The rod samples were cured using a Fusion D bulb at a dose of about 2.4 J/cm² (measured over a wavelength range of 225-424 nm by a Light Bug model IL390 from International Light). After curing, the Teflon® tubing was stripped away to provide a cured rod sample of the high-modulus coating composition. The cured rods were allowed to condition for 18-24 hours at 23° C. and 50% relative humidity before testing. Young's modulus, tensile strength at break, yield strength, and elongation at yield were measured using a Sintech MTS Tensile Tester on defect-free rod samples with a gauge length of 51 mm, and a test speed of 250 mm/min. Tensile properties were measured according to ASTM Standard D882-97. The properties were determined as an average of at least five samples, with defective samples being excluded from the average.

In Situ Glass Transition Temperature. In situ T_{g} measurements were performed on fiber tube-off samples obtained from fibers having a low-modulus inner coating surrounded by a high-modulus coating. The coated fibers included a glass fiber having a diameter of 125 microns, a low-modulus inner coating with thickness 32.5 microns surrounding and in direct contact with the glass fiber, and a high-modulus coating with thickness 26.0 microns surrounding and in direct contact with the glass fiber. The glass fiber and low-modulus inner coating were the same for all samples measured. The low-modulus inner coating was formed from the reference low-modulus inner coating composition described below. Samples with a comparative high-modulus coating and a high-modulus coating in accordance with the present disclosure were measured.

The fiber tube-off samples were obtained using the following procedure: a 0.0055″ Miller stripper was clamped down approximately 1 inch from the end of the coated fiber. The one-inch region of fiber was plunged into a stream of liquid nitrogen and held in the liquid nitrogen for 3 seconds. The coated fiber was then removed from the stream of liquid nitrogen and quickly stripped to remove the coating. The stripped end of the fiber was inspected for residual coating. If residual coating remained on the glass fiber, the sample was discarded, and a new sample was prepared. The result of the stripping process was a clean glass fiber and a hollow tube of stripped coating that includes the intact low-modulus inner coating and the high-modulus coating. The hollow tube is referred to as a “tube-off sample”. The diameters of the glass, low-modulus inner coating and high-modulus coating were measured from the end-face of the unstripped fiber.

In-situ Tg of the tube-off samples was run using a Rheometrics DMTA IV test instrument at a sample gauge length of 9 to 10 mm. The width, thickness, and length of the tube-off sample were input to the operating program of the test instrument. The tube-off sample was mounted and then cooled to approximately −85° C. Once stable, the temperature ramp was run using the following parameters:
Frequency: 1 Hz
Strain: 0.3%
Heating Rate: 2° C./min.
Final Temperature: 150° C.
Initial Static Force=20.0 g
Static >Dynamic Force by=10.0%

The in-situ Tg of a coating is defined as the maximum value of tan δ in a plot of tan δ as a function of temperature, where tan δ is defined as:

$$tan δ = {E}^{″} / {E}^{′}$$

and E″ is the loss modulus, which is proportional to the loss of energy as heat in a cycle of deformation and E′ is the storage or elastic modulus, which is proportional to the energy stored in a cycle of deformation.

The tube-off samples exhibited distinct maxima in the tan δ plot for the low-modulus inner coating and high-modulus coating. The maximum at lower temperature (about −50° C.) corresponded to the in-situ Tg for the low-modulus inner coating and the maximum at higher temperature (above 50° C.) corresponded to the in-situ Tg for the high-modulus coating.

In Situ Modulus of Low-Modulus Inner Coating. In embodiments that include this optional coating layer, the in situ modulus was measured using the following procedure. A six-inch sample of fiber was obtained and a one-inch section from the center of the fiber was window-stripped and wiped with isopropyl alcohol. The window-stripped fiber was mounted on a sample holder/alignment stage equipped with 10 mm×5 mm rectangular aluminium tabs that were used to affix the fiber. Two tabs were oriented horizontally and positioned so that the short 5 mm sides were facing each other and separated by a 5 mm gap. The window-stripped fiber was laid horizontally on the sample holder across the tabs and over the gap separating the tabs. The coated end of one side of the window-stripped region of the fiber was positioned on one tab and extended halfway into the 5 mm gap between the tabs. The one-inch window-stripped region extended over the remaining half of the gap and across the opposing tab. After alignment, the sample was removed, and a small dot of glue was applied to the half of each tab closest to the 5 mm gap. The fiber was then returned to position and the alignment stage was raised until the glue just touched the fiber. The coated end was then pulled away from the gap and through the glue such that the majority of the 5 mm gap between the tabs was occupied by the window-stripped region of the fiber. The portion of the window-stripped region remaining on the opposing tab was in contact with the glue. The very tip of the coated end was left to extend beyond the tab and into the gap between the tabs. This portion of the coated end was not embedded in the glue and was the object of the in situ modulus measurement. The glue was allowed to dry with the fiber sample in this configuration to affix the fiber to the tabs. After drying, the length of fiber fixed to each of the tabs was trimmed to 5 mm. The coated length embedded in glue, the non-embedded coated length (the portion extending into the gap between the tabs), and the primary diameter were measured.

The in situ modulus measurements were performed on a Rheometrics DMTA IV dynamic mechanical testing apparatus at a constant strain of 9e-6 1/s for a time of forty-five minutes at room temperature (21° C.). The gauge length was 15 mm. Force and the change in length were recorded and used to calculate the in situ modulus of the low-modulus coating. The tab-mounted fiber samples were prepared by removing any epoxy from the tabs that would interfere with the 15 mm clamping length of the testing apparatus to ensure that there was no contact of the clamps with the fiber and that the sample was secured squarely to the clamps. The instrument force was zeroed out. The tab to which the non-coated end of the fiber was affixed was then mounted to the lower clamp (measurement probe) of the testing apparatus and the tab to which the coated end of the fiber was affixed was mounted to the upper (fixed) clamp of the testing apparatus. The test was then executed, and the sample was removed once the analysis was completed.

In Situ Modulus of the High-Modulus Coating. For the high-modulus coating, the in situ modulus was measured using fiber tube-off samples prepared from the fiber samples. A 0.0055 inch Miller stripper was clamped down approximately 1 inch from the end of the fiber sample. This one-inch region of fiber sample was immersed into a stream of liquid nitrogen and held for 3 seconds. The fiber sample was then removed and quickly stripped. The stripped end of the fiber sample was then inspected. If coating remained on the glass portion of the fiber sample, the tube-off sample was deemed defective and a new tube-off sample was prepared. A proper tube-off sample is one that stripped clean from the glass and consists of a hollow tube with a low-modulus inner coating and the high-modulus coating. The diameters of the glass, the low-modulus inner coating, and the high-modulus coating were measured from the end-face of the unstripped fiber sample.

The fiber tube-off samples were run using a Rheometrics DMTA IV instrument at a sample gauge length 11 mm to obtain the in situ modulus of the high-modulus coating. The width, thickness, and length were determined and provided as input to the operating software of the instrument. The sample was mounted and run using a time sweep program at ambient temperature (21° C.) using the following parameters:
Frequency: 1 Rad/sec
Strain: 0.3%
Total Time=120 sec.
Time Per Measurement=1 sec
Initial Static Force=15.0 g
Static>Dynamic Force by=10.0%
   Once completed, the last five E′ (storage modulus) data points were averaged. Each sample was run three times (fresh sample for each run) for a total of fifteen data points. The averaged value of the three runs was reported.

Puncture Resistance of the High-Modulus Coating. Puncture resistance measurements were made on samples that included a glass fiber, and a low-modulus inner coating surrounded by a high-modulus coating. The glass fiber had a cladding diameter of 125 microns. The low-modulus inner coating was formed from the reference low-modulus inner coating composition listed in Table 10 below. Samples with various high-modulus coatings were prepared as described below. The thicknesses of the low-modulus inner coating and high-modulus coating were adjusted to vary the cross-sectional area of the high-modulus coating as described below. The ratio of the thickness of the high-modulus coating to the thickness of the low-modulus inner coating was maintained at about 0.8 for all samples.

The puncture resistance was measured using the technique described in the article entitled “Quantifying the Puncture Resistance of Optical Fiber Coatings”, by G. Scott Glaesemann and Donald A. Clark, published in the Proceedings of the 52^{nd} International Wire & Cable Symposium, pp. 237-245 (2003), which incorporated by reference herein. A summary of the method is provided here. The method is an indentation method. A 4-centimeter length of optical fiber was placed on a 3 mm-thick glass slide. One end of the optical fiber was attached to a device that permitted rotation of the optical fiber in a controlled fashion. The optical fiber was examined in transmission under 100× magnification and rotated until the thickness of the high-modulus coating was equivalent on both sides of the glass fiber in a direction parallel to the glass slide. In this position, the thickness of the high-modulus coating was equal on both sides of the optical fiber in a direction parallel to the glass slide. The thickness of the high-modulus coating in the directions normal to the glass slide and above or below the glass fiber differed from the thickness of the high-modulus coating in the direction parallel to the glass slide. One of the thicknesses in the direction normal to the glass slide was greater and the other of the thicknesses in the direction normal to the glass slide was less than the thickness in the direction parallel to the glass slide. This position of the optical fiber was fixed by taping the optical fiber to the glass slide at both ends and is the position of the optical fiber used for the indentation test.

Indentation was carried out using a universal testing machine (Instron model 5500R or equivalent). An inverted microscope was placed beneath the crosshead of the testing machine. The objective of the microscope was positioned directly beneath a Vickers diamond wedge indenter, with an included angle of 75°, that was installed in the testing machine. The glass slide with taped fiber was placed on the microscope stage and positioned directly beneath the indenter such that the width of the indenter wedge was orthogonal to the direction of the optical fiber. With the optical fiber in place, the diamond wedge was lowered until it contacted the surface of the high-modulus coating. The diamond wedge was then driven into the high-modulus coating at a rate of 0.1 mm/min and the load on the high-modulus coating was measured. The load on the high-modulus coating increased as the diamond wedge was driven deeper into the high-modulus coating until puncture occurred, at which point a precipitous decrease in load was observed. The indentation load at which puncture was observed was recorded and is reported herein as grams of force (g) and referred to herein as “puncture load”. The experiment was repeated with the optical fiber in the same orientation to obtain ten measurement points, which were averaged to determine a puncture load for the orientation. A second set of ten measurement points was taken by rotating the orientation of the optical fiber by 180°.

Macrobending Loss. Macrobending loss was determined using the mandrel wrap test specified in standard IEC 60793-1-47. In the mandrel wrap test, the fiber is wrapped one or more times around a cylindrical mandrel having a specified diameter, and the increase in attenuation at a specified wavelength due to the bending is determined. Attenuation in the mandrel wrap test is expressed in units of dB/turn, where one turn refers to one revolution of the fiber about the the mandrel. Macrobending losses at a wavelength of 1310 nm, 1550 nm and 1625 nm were determined for selected examples described below with the mandrel wrap test using mandrels with diameters of 10 mm, 15 mm and 20 mm.

Exemplary Embodiments of Optical Fibers with Low-Modulus Inner Coatings surrounded by High-Modulus Coatings

The specific properties of the low-modulus inner coating 22 and high-modulus coating 24 may be tailored to provide sufficient robustness and good microbending performance for the smaller diameter fibers disclosed herein. For example, low-modulus inner coating 22 may have a low Young's modulus and/or a low in situ modulus. The Young's modulus of the low-modulus inner coating is less than or equal to about 0.7 MPa, or less than or equal to about 0.6 MPa, or less than or equal to 0.5 about MPa, or less than or equal to about 0.4 MPa, or in the range from about 0.1 MPa to about 0.7 MPa, or in the range from about 0.1 MPa to about 0.4 MPa. The in situ modulus of the low-modulus inner coating is less than or equal to about 0.50 MPa, or less than or equal to about 0.30 MPa, or less than or equal to about 0.25 MPa, or less than or equal to about 0.20 MPa, or less than or equal to about 0.15 MPa, or less than or equal to about 0.10 MPa, or in the range from about 0.05 MPa to about 0.25 MPa, or in the range from about 0.10 MPa to about 0.20 MPa.

Low-modulus inner coating 22 preferably has a higher refractive index than cladding region 20 of the glass fiber in order to allow it to strip errant optical signals away from core region 18. Low-modulus inner coating 22 should maintain adequate adhesion to the glass fiber during thermal and hydrolytic aging, yet still be strippable from the glass fiber for splicing purposes.

To facilitate smaller diameter optical fibers, the low-modulus inner coating may be absent or have a smaller thickness than the low-modulus inner coating used in conventional optical fibers. The high-modulus coating 24 may have a smaller thickness and a smaller cross-sectional area compared to conventional optical fibers. However, high-modulus coating 24 must still maintain the required robustness and puncture resistance needed for high reliability in undersea cables and repeaters. As the thickness of the high-modulus coating decreases, its protective function diminishes. Puncture resistance is a measure of the protective function of the cross-sectional area of the outer coatings, which include the high-modulus coating and the optional pigmented outer coating. A high-modulus coating with a higher puncture resistance withstands higher abrasive pressures without failing and provides better protection for the glass fiber.

In order to provide the required robustness and puncture resistance, high-modulus coating 24 may have an in situ modulus greater than about 1500 MPa, or greater than about 1600 MPa, or greater than about 1800 MPa, or greater than about 2200 MPa, or greater than about 2500 MPa, or greater than about 2600 MPa, or greater than about 2700 MPa, or in the range from about 1500 MPa to about 3000 MPa, or in the range from about 1800 MPa to about 2800 MPa, or in the range from about 2000 MPa to about 2800 MPa, or in the range from about 2400 MPa to about 2800 MPa.

In order to further provide the required robustness and puncture resistance, the product of the cross-sectional area and the in situ modulus of the high-modulus coating 24 may be greater than about 10 N, greater than about 12.5 N, greater than about 15 N, greater than about 20 N, greater than about 25 N, greater than about 30 N, or in the range from about 10 N to 30 N, or in the range from about 15 N to about 30 N, or in the range from about 20 N to about 30 N, or in the range from about 25 N to about 30 N.

In order to provide the required combination of low good microbending performance and puncture resistance, the ratio of the in situ modulus of the high-modulus coating 24 to the in situ modulus of the low-modulus coating 22 may be greater than about 4000, or greater than about 5000, or greater than about 6000, or greater than about 7000, or greater than about 8000, or greater than about 9000, or greater than about 10,000, or in the range from about 4000 to about 10,000, or in the range from about 4000 to about 10,000, or in the range from about 5000 to about 10,000, or in the range from about 6000 to about 10,000, or in the range from about 7000 to about 10,000, or in the range from about 8000 to about 10,000.

Low-modulus and high-modulus coatings are typically formed by applying a curable coating composition to the glass fiber as a viscous liquid and curing. The optical fiber may also include a pigmented outer coating that surrounds the high-modulus coating. The pigmented outer coating may include coloring agents to mark the optical fiber for identification purposes and typically has a Young's modulus similar to the Young's modulus of the high-modulus coating.

High-modulus coating 24 may be comprised of a trifunctional monomer. A glass transition temperature (Tg) of high-modulus coating 24 may be greater than about 50° C., or greater than about 60° C., or greater than about 70° C., or greater than about 80° C., or greater than about 90° C., or greater than about 100° C.

Suitable low-modulus inner coatings 22 and high-modulus coatings 24 may be used so that optical fiber 12 has a puncture resistance greater than or equal to about 28 g, or greater than or equal to about 30 g, or greater than or equal to about 32 g, or greater than or equal to about 34 g, or greater than or equal to about 36 g, or greater than or equal to about 38 g, or greater than or equal to about 40 g, when the cross-sectional area of the high-modulus coating is less than about 10,000 microns².

Suitable low-modulus inner coatings 22 and high-modulus coatings 24 may be used so that optical fiber 12 has a puncture resistance greater than or equal to about 22 g, or greater than or equal to about 24 g, or greater than or equal to about 26 g, or greater than or equal to about 28 g, or greater than or equal to about 30 g, when the cross-sectional area of the high-modulus coating is less than about 8,000 microns².

FIG. 15 depicts the microbend attenuation penalty (MAP) versus the low-modulus inner coating thickness for fibers having step-index and trench-assisted profiles, a cladding diameter of 100 microns, a high-modulus coating having a modulus of 1200 MPa and an outer radius of 82.5 microns, and a low-modulus inner coating having a modulus of 0.5 MPa. As shown in FIG. 15 and Table 4, a MAP less than 0.1 dB/km can be achieved when the fiber has a trench-assisted profile, a cladding diameter of about 100 microns, and the thickness of the low-modulus inner coating is between about 10 microns and about 26 microns.

TABLE 4
(MAP for fibers having step-index and trench-assisted profiles with a cladding
diameter of 100 microns, Ep = 0.5 MPa and Es = 1200 MPa)

| | Low-modulus | Low-modulus | High-modulus | High-modulus | MAP of | MAP of |
|---|---|---|---|---|---|---|
| Glass | Inner Coating | Inner Coating | Coating | Coating | Step- | Trench- |
| Radius, | Thickness, | Radius, | Radius, | Thickness, | index | assisted |
| R_g | t_p | R_p | R_s | t_s | profile | profile |
| (microns) | (microns) | (microns) | (microns) | (microns) | (dB/km) | (dB/km) |
| 50 | 5 | 55 | 82.5 | 27.5 | 0.522 | 0.261 |
| 50 | 6 | 56 | 82.5 | 26.5 | 0.382 | 0.191 |
| 50 | 7 | 57 | 82.5 | 25.5 | 0.297 | 0.148 |
| 50 | 8 | 58 | 82.5 | 24.5 | 0.241 | 0.120 |
| 50 | 9 | 59 | 82.5 | 23.5 | 0.202 | 0.101 |
| 50 | 10 | 60 | 82.5 | 22.5 | 0.174 | 0.087 |
| 50 | 11 | 61 | 82.5 | 21.5 | 0.154 | 0.077 |
| 50 | 12 | 62 | 82.5 | 20.5 | 0.139 | 0.069 |
| 50 | 13 | 63 | 82.5 | 19.5 | 0.128 | 0.064 |
| 50 | 14 | 64 | 82.5 | 18.5 | 0.119 | 0.059 |
| 50 | 15 | 65 | 82.5 | 17.5 | 0.113 | 0.056 |
| 50 | 16 | 66 | 82.5 | 16.5 | 0.108 | 0.054 |
| 50 | 17 | 67 | 82.5 | 15.5 | 0.105 | 0.053 |
| 50 | 18 | 68 | 82.5 | 14.5 | 0.104 | 0.052 |
| 50 | 19 | 69 | 82.5 | 13.5 | 0.104 | 0.052 |
| 50 | 20 | 70 | 82.5 | 12.5 | 0.105 | 0.052 |
| 50 | 21 | 71 | 82.5 | 11.5 | 0.108 | 0.054 |
| 50 | 22 | 72 | 82.5 | 10.5 | 0.112 | 0.056 |
| 50 | 23 | 73 | 82.5 | 9.5 | 0.118 | 0.059 |
| 50 | 24 | 74 | 82.5 | 8.5 | 0.126 | 0.063 |
| 50 | 25 | 75 | 82.5 | 7.5 | 0.137 | 0.069 |
| 50 | 26 | 76 | 82.5 | 6.5 | 0.151 | 0.075 |
| 50 | 27 | 77 | 82.5 | 5.5 | 0.168 | 0.084 |
| 50 | 28 | 78 | 82.5 | 4.5 | 0.189 | 0.094 |
| 50 | 29 | 79 | 82.5 | 3.5 | 0.216 | 0.108 |
| 50 | 30 | 80 | 82.5 | 2.5 | 0.256 | 0.128 |
| 50 | 31 | 81 | 82.5 | 1.5 | 0.333 | 0.166 |

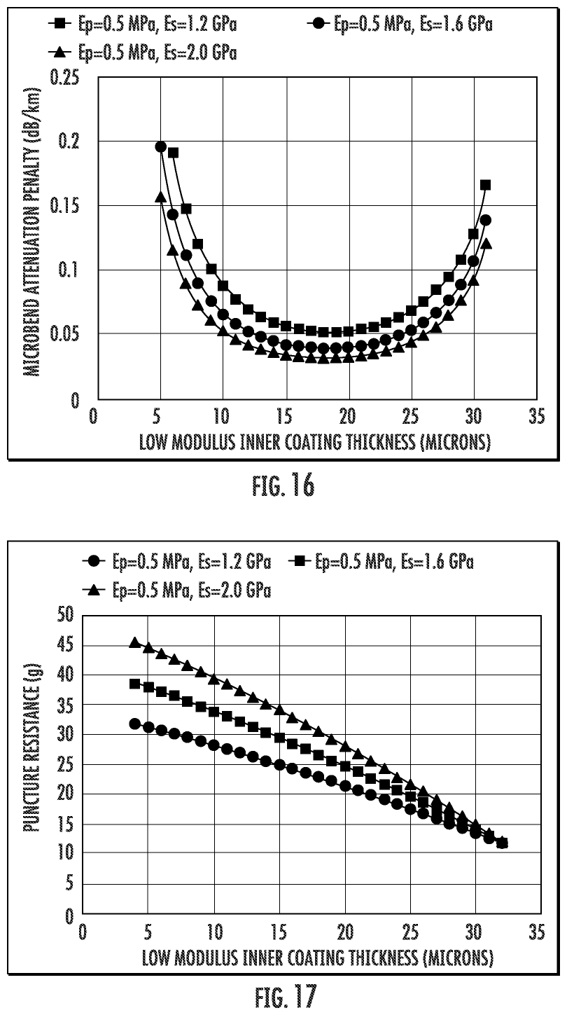

FIG. 16 depicts the MAP versus the thickness of the low-modulus inner coating for fibers having trench-assisted fiber profiles, a cladding diameter of 100 microns, a low-modulus inner coating having a modulus of 0.5 MPa and a high-modulus coatings having moduli of 1.2, 1.6 and 2.0 GPa. As shown in FIG. 16 and Table 5, a MAP less than 0.1 dB/km can be achieved when the high-modulus coating has a modulus of 1.6 GPa and the thickness of the low-modulus inner coating is between about 8 and about 29 microns. A MAP less than 0.05 dB/km can be achieved when the high-modulus coating has a modulus of 1.6 GPa and the thickness of the low-modulus inner coating is between about 13 and about 24 microns. A MAP less than 0.1 dB/km can be achieved when the high-modulus coating has a modulus of 2.0 GPa and the thickness of the low-modulus inner coating is between about 7 and about 30 microns. A MAP less than 0.05 dB/km can be achieved when the high-modulus coating has a modulus of 2.0 GPa and the thickness of the low-modulus inner coating is between about 11 and about 26 microns.

TABLE 5
(MAP for fibers having trench-assisted profiles with a cladding diameter of 100 microns and Ep = 0.5 MPa)

| | Low-modulus | Low-modulus | High-modulus | High-modulus | | | |
|---|---|---|---|---|---|---|---|
| Glass | Inner Coating | Inner Coating | Coating | Coating | MAP for | MAP for | MAP for |
| Radius, | Thickness, | Radius, | Radius, | Thickness, | Es = 1.2 | Es = 1.6 | Es = 2.0 |
| R_g | t_p | R_p | R_s | t_s | GPa | GPa | GPa |
| (microns) | (microns) | (microns) | (microns) | (microns) | (dB/km) | (dB/km) | (dB/km) |
| 50 | 5 | 55 | 82.5 | 27.5 | 0.261 | 0.196 | 0.157 |
| 50 | 6 | 56 | 82.5 | 26.5 | 0.191 | 0.144 | 0.115 |
| 50 | 7 | 57 | 82.5 | 25.5 | 0.148 | 0.111 | 0.089 |
| 50 | 8 | 58 | 82.5 | 24.5 | 0.120 | 0.090 | 0.072 |
| 50 | 9 | 59 | 82.5 | 23.5 | 0.101 | 0.076 | 0.061 |
| 50 | 10 | 60 | 82.5 | 22.5 | 0.087 | 0.066 | 0.052 |
| 50 | 11 | 61 | 82.5 | 21.5 | 0.077 | 0.058 | 0.046 |
| 50 | 12 | 62 | 82.5 | 20.5 | 0.069 | 0.052 | 0.042 |
| 50 | 13 | 63 | 82.5 | 19.5 | 0.064 | 0.048 | 0.038 |
| 50 | 14 | 64 | 82.5 | 18.5 | 0.059 | 0.045 | 0.036 |
| 50 | 15 | 65 | 82.5 | 17.5 | 0.056 | 0.042 | 0.034 |
| 50 | 16 | 66 | 82.5 | 16.5 | 0.054 | 0.041 | 0.033 |
| 50 | 17 | 67 | 82.5 | 15.5 | 0.053 | 0.040 | 0.032 |
| 50 | 18 | 68 | 82.5 | 14.5 | 0.052 | 0.039 | 0.031 |
| 50 | 19 | 69 | 82.5 | 13.5 | 0.052 | 0.039 | 0.032 |
| 50 | 20 | 70 | 82.5 | 12.5 | 0.052 | 0.040 | 0.032 |
| 50 | 21 | 71 | 82.5 | 11.5 | 0.054 | 0.041 | 0.033 |
| 50 | 22 | 72 | 82.5 | 10.5 | 0.056 | 0.043 | 0.034 |
| 50 | 23 | 73 | 82.5 | 9.5 | 0.059 | 0.045 | 0.037 |
| 50 | 24 | 74 | 82.5 | 8.5 | 0.063 | 0.049 | 0.040 |
| 50 | 25 | 75 | 82.5 | 7.5 | 0.069 | 0.053 | 0.044 |
| 50 | 26 | 76 | 82.5 | 6.5 | 0.075 | 0.059 | 0.049 |
| 50 | 27 | 77 | 82.5 | 5.5 | 0.084 | 0.067 | 0.056 |
| 50 | 28 | 78 | 82.5 | 4.5 | 0.094 | 0.076 | 0.064 |
| 50 | 29 | 79 | 82.5 | 3.5 | 0.108 | 0.089 | 0.076 |
| 50 | 30 | 80 | 82.5 | 2.5 | 0.128 | 0.106 | 0.092 |
| 50 | 31 | 81 | 82.5 | 1.5 | 0.166 | 0.139 | 0.121 |

FIG. 17 depicts the puncture resistance versus the thickness of the low-modulus inner coating for fibers having a trench-assisted profile, a cladding diameter of 100 microns, a low-modulus coating having a modulus of 0.5 MPa and a high-modulus coatings having moduli of 1.2, 1.6 and 2.0 GPa. As shown in FIG. 17 and Table 6, a puncture resistance greater than 30 g can be achieved when the high-modulus coating has a modulus of 1.6 GPa and the thickness of the low-modulus inner coating is less than about 14 microns. A puncture resistance greater than 35 g can be achieved when the high-modulus coating has a modulus of 1.6 GPa and the thickness of the low-modulus inner coating is less than about 8 microns. A puncture resistance greater than 30 g can be achieved when the high-modulus coating has a modulus of 2.0 GPa and the thickness of the low-modulus inner coating is less than about 18 microns. A puncture resistance greater than 35 g can be achieved when the high-modulus coating has a modulus of 2.0 GPa and the thickness of the low-modulus inner coating is less than about 14 microns. A puncture resistance greater than 40 g can be achieved when the high-modulus coating has a modulus of 2.0 GPa and the thickness of the low-modulus inner coating is less than about 9 microns.

TABLE 6
(Puncture resistance for fibers having trench-assisted profiles
with a cladding diameter of 100 microns and Ep = 0.5 MPa)

| | Low-modulus | Low-modulus | High-modulus | High-modulus | Puncture | Puncture | Puncture |
|---|---|---|---|---|---|---|---|
| Glass | Inner Coating | Inner Coating | Coating | Coating | Resistance | Resistance | Resistance |
| Radius, | Thickness, | Radius, | Radius, | Thickness, | for Es = 1.2 | for Es = 1.6 | for Es = 2.0 |
| R_g | t_p | R_p | R_s | t_s | GPa | GPa | GPa |
| (microns) | (microns) | (microns) | (microns) | (microns) | (g) | (g) | (g) |
| 50 | 5 | 55 | 82.5 | 27.5 | 31.2 | 37.9 | 44.5 |
| 50 | 6 | 56 | 82.5 | 26.5 | 30.6 | 37.1 | 43.5 |
| 50 | 7 | 57 | 82.5 | 25.5 | 30.0 | 36.3 | 42.5 |
| 50 | 8 | 58 | 82.5 | 24.5 | 29.4 | 35.5 | 41.5 |
| 50 | 9 | 59 | 82.5 | 23.5 | 28.8 | 34.7 | 40.5 |
| 50 | 10 | 60 | 82.5 | 22.5 | 28.2 | 33.8 | 39.5 |
| 50 | 11 | 61 | 82.5 | 21.5 | 27.5 | 33.0 | 38.4 |
| 50 | 12 | 62 | 82.5 | 20.5 | 26.9 | 32.1 | 37.3 |
| 50 | 13 | 63 | 82.5 | 19.5 | 26.2 | 31.2 | 36.2 |
| 50 | 14 | 64 | 82.5 | 18.5 | 25.6 | 30.3 | 35.1 |
| 50 | 15 | 65 | 82.5 | 17.5 | 24.9 | 29.4 | 34.0 |
| 50 | 16 | 66 | 82.5 | 16.5 | 24.2 | 28.5 | 32.8 |
| 50 | 17 | 67 | 82.5 | 15.5 | 23.5 | 27.6 | 31.6 |
| 50 | 18 | 68 | 82.5 | 14.5 | 22.8 | 26.6 | 30.5 |
| 50 | 19 | 69 | 82.5 | 13.5 | 22.0 | 25.6 | 29.2 |
| 50 | 20 | 70 | 82.5 | 12.5 | 21.3 | 24.7 | 28.0 |
| 50 | 21 | 71 | 82.5 | 11.5 | 20.6 | 23.7 | 26.8 |
| 50 | 22 | 72 | 82.5 | 10.5 | 19.8 | 22.7 | 25.5 |
| 50 | 23 | 73 | 82.5 | 9.5 | 19.1 | 21.7 | 24.2 |
| 50 | 24 | 74 | 82.5 | 8.5 | 18.3 | 20.6 | 23.0 |
| 50 | 25 | 75 | 82.5 | 7.5 | 17.5 | 19.6 | 21.6 |
| 50 | 26 | 76 | 82.5 | 6.5 | 16.7 | 18.5 | 20.3 |
| 50 | 27 | 77 | 82.5 | 5.5 | 15.9 | 17.4 | 19.0 |
| 50 | 28 | 78 | 82.5 | 4.5 | 15.1 | 16.3 | 17.6 |
| 50 | 29 | 79 | 82.5 | 3.5 | 14.2 | 15.2 | 16.2 |
| 50 | 30 | 80 | 82.5 | 2.5 | 13.4 | 14.1 | 14.8 |
| 50 | 31 | 81 | 82.5 | 1.5 | 12.5 | 13.0 | 13.4 |

FIG. 18 depicts the MAP versus the thickness of the low-modulus inner coating for fibers having a trench-assisted fiber profile, a cladding diameter of 100 microns, a high-modulus coating having a modulus of 1.6 GPa and low-modulus inner coatings having moduli of 0.5, 0.35 and 0.2 MPa. As shown in FIG. 18 and Table 7, a MAP less than 0.05 dB/km can be achieved when the low-modulus inner coating has a modulus of 0.35 MPa and the thickness of the low-modulus inner coating is between about 8 and about 29 microns. A MAP less than 0.02 dB/km can be achieved when the low-modulus inner coating has a modulus of 0.35 MPa and the thickness of the low-modulus inner coating is between about 16 and about 21 microns. A MAP less than 0.05 dB/km can be achieved when the low-modulus inner coating has a modulus of 0.2 MPa and the thickness of the low-modulus inner coating is between about 4 and about 31 microns. A MAP less than 0.02 dB/km can be achieved when the low-modulus inner coating has a modulus of 0.2 MPa and the thickness of the low-modulus inner coating is between about 7 and about 29 microns. A MAP less than 0.01 dB/km can be achieved when the low-modulus inner coating has a modulus of 0.2 MPa and the thickness of the low-modulus inner coating is between about 11 and about 25 microns. A MAP less than 0.007 dB/km can be achieved when the low-modulus inner coating has a modulus of 0.2 MPa and the thickness of the low-modulus inner coating is between about 16 and about 21 microns.

TABLE 7
(MAP for fibers having trench-assisted profiles with a cladding diameter of 100 microns and Es = 1.6 GPa)

| | Low-modulus | Low-modulus | High-modulus | High-modulus | | | |
|---|---|---|---|---|---|---|---|
| Glass | Inner Coating | Inner Coating | Coating | Coating | MAP for | MAP for | MAP for |
| Radius, | Thickness, | Radius, | Radius, | Thickness, | Ep = 0.5 | Ep = 0.35 | Ep = 0.2 |
| R_g | t_p | R_p | R_s | t_s | MPa | MPa | MPa |
| (microns) | (microns) | (microns) | (microns) | (microns) | (dB/km) | (dB/km) | (dB/km) |
| 50 | 5 | 55 | 82.5 | 27.5 | 0.196 | 0.096 | 0.031 |
| 50 | 6 | 56 | 82.5 | 26.5 | 0.144 | 0.070 | 0.023 |
| 50 | 7 | 57 | 82.5 | 25.5 | 0.111 | 0.055 | 0.018 |
| 50 | 8 | 58 | 82.5 | 24.5 | 0.090 | 0.044 | 0.015 |
| 50 | 9 | 59 | 82.5 | 23.5 | 0.076 | 0.037 | 0.012 |
| 50 | 10 | 60 | 82.5 | 22.5 | 0.066 | 0.032 | 0.011 |
| 50 | 11 | 61 | 82.5 | 21.5 | 0.058 | 0.028 | 0.009 |
| 50 | 12 | 62 | 82.5 | 20.5 | 0.052 | 0.026 | 0.008 |
| 50 | 13 | 63 | 82.5 | 19.5 | 0.048 | 0.024 | 0.008 |
| 50 | 14 | 64 | 82.5 | 18.5 | 0.045 | 0.022 | 0.007 |
| 50 | 15 | 65 | 82.5 | 17.5 | 0.042 | 0.021 | 0.007 |
| 50 | 16 | 66 | 82.5 | 16.5 | 0.041 | 0.020 | 0.007 |
| 50 | 17 | 67 | 82.5 | 15.5 | 0.040 | 0.020 | 0.006 |
| 50 | 18 | 68 | 82.5 | 14.5 | 0.039 | 0.019 | 0.006 |
| 50 | 19 | 69 | 82.5 | 13.5 | 0.039 | 0.019 | 0.006 |
| 50 | 20 | 70 | 82.5 | 12.5 | 0.040 | 0.020 | 0.006 |
| 50 | 21 | 71 | 82.5 | 11.5 | 0.041 | 0.020 | 0.007 |
| 50 | 22 | 72 | 82.5 | 10.5 | 0.043 | 0.021 | 0.007 |
| 50 | 23 | 73 | 82.5 | 9.5 | 0.045 | 0.023 | 0.008 |
| 50 | 24 | 74 | 82.5 | 8.5 | 0.049 | 0.024 | 0.008 |
| 50 | 25 | 75 | 82.5 | 7.5 | 0.053 | 0.027 | 0.009 |
| 50 | 26 | 76 | 82.5 | 6.5 | 0.059 | 0.030 | 0.010 |
| 50 | 27 | 77 | 82.5 | 5.5 | 0.067 | 0.035 | 0.012 |
| 50 | 28 | 78 | 82.5 | 4.5 | 0.076 | 0.041 | 0.015 |
| 50 | 29 | 79 | 82.5 | 3.5 | 0.089 | 0.048 | 0.018 |
| 50 | 30 | 80 | 82.5 | 2.5 | 0.106 | 0.059 | 0.023 |
| 50 | 31 | 81 | 82.5 | 1.5 | 0.139 | 0.078 | 0.031 |

Table 8 depicts the MAP versus the thickness of the low-modulus inner coating for fibers having a trench-assisted fiber profile (e.g. as shown in Table 2 above), a cladding diameter of 100 microns, a high-modulus coating having a modulus of 2.0 GPa and low-modulus inner coatings having moduli of 0.35, 0.2 and 0.1 MPa. As shown in Table 8, a MAP less than 0.02 dB/km can be achieved when the low-modulus inner coating has a modulus of 0.35 MPa and the thickness of the low-modulus inner coating is between about 6 and about 30 microns. A MAP less than 0.02 dB/km can be achieved when the low-modulus inner coating has a modulus of 0.35 MPa and the thickness of the low-modulus inner coating is between about 13 and about 23 microns. A MAP less than 0.02 dB/km can be achieved when the low-modulus inner coating has a modulus of 0.2 MPa and the thickness of the low-modulus inner coating is between about 6 and about 30 microns. A MAP less than 0.01 dB/km can be achieved when the low-modulus inner coating has a modulus of 0.2 MPa and the thickness of the low-modulus inner coating is between about 9 and about 27 microns. A MAP less than 0.005 dB/km can be achieved when the low-modulus inner coating has a modulus of 0.2 MPa and the thickness of the low-modulus inner coating is between about 14 and about 22 microns. A MAP less than 0.005 dB/km can be achieved when the low-modulus inner coating has a modulus of 0.1 MPa and the thickness of the low-modulus inner coating is between about 6 and about 29 microns. A MAP less than 0.002 dB/km can be achieved when the low-modulus inner coating has a modulus of 0.1 MPa and the thickness of the low-modulus inner coating is between about 13 and about 23 microns.

TABLE 8
(MAP for fibers having trench-assisted profiles with a cladding diameter of 100 microns and Es = 2.0 GPa)

| | Low-modulus | Low-modulus | High-modulus | High-modulus | | | |
|---|---|---|---|---|---|---|---|
| Glass | Inner Coating | Inner Coating | Coating | Coating | MAP for | MAP for | MAP for |
| Radius, | Thickness, | Radius, | Radius, | Thickness, | Ep = 0.35 | Ep = 0.2 | Ep = 0.1 |
| R_g | t_p | R_p | R_s | t_s | MPa | MPa | MPa |
| (microns) | (microns) | (microns) | (microns) | (microns) | (dB/km) | (dB/km) | (dB/km) |
| 50 | 5 | 55 | 82.5 | 27.5 | 0.077 | 0.025 | 0.006 |
| 50 | 6 | 56 | 82.5 | 26.5 | 0.056 | 0.018 | 0.005 |
| 50 | 7 | 57 | 82.5 | 25.5 | 0.044 | 0.014 | 0.004 |
| 50 | 8 | 58 | 82.5 | 24.5 | 0.036 | 0.012 | 0.003 |
| 50 | 9 | 59 | 82.5 | 23.5 | 0.030 | 0.010 | 0.002 |
| 50 | 10 | 60 | 82.5 | 22.5 | 0.026 | 0.008 | 0.002 |
| 50 | 11 | 61 | 82.5 | 21.5 | 0.023 | 0.007 | 0.002 |
| 50 | 12 | 62 | 82.5 | 20.5 | 0.021 | 0.007 | 0.002 |
| 50 | 13 | 63 | 82.5 | 19.5 | 0.019 | 0.006 | 0.002 |
| 50 | 14 | 64 | 82.5 | 18.5 | 0.018 | 0.006 | 0.001 |
| 50 | 15 | 65 | 82.5 | 17.5 | 0.017 | 0.005 | 0.001 |
| 50 | 16 | 66 | 82.5 | 16.5 | 0.016 | 0.005 | 0.001 |
| 50 | 17 | 67 | 82.5 | 15.5 | 0.016 | 0.005 | 0.001 |
| 50 | 18 | 68 | 82.5 | 14.5 | 0.015 | 0.005 | 0.001 |
| 50 | 19 | 69 | 82.5 | 13.5 | 0.016 | 0.005 | 0.001 |
| 50 | 20 | 70 | 82.5 | 12.5 | 0.016 | 0.005 | 0.001 |
| 50 | 21 | 71 | 82.5 | 11.5 | 0.016 | 0.005 | 0.001 |
| 50 | 22 | 72 | 82.5 | 10.5 | 0.017 | 0.006 | 0.001 |
| 50 | 23 | 73 | 82.5 | 9.5 | 0.018 | 0.006 | 0.002 |
| 50 | 24 | 74 | 82.5 | 8.5 | 0.020 | 0.007 | 0.002 |
| 50 | 25 | 75 | 82.5 | 7.5 | 0.022 | 0.007 | 0.002 |
| 50 | 26 | 76 | 82.5 | 6.5 | 0.025 | 0.008 | 0.002 |
| 50 | 27 | 77 | 82.5 | 5.5 | 0.029 | 0.010 | 0.003 |
| 50 | 28 | 78 | 82.5 | 4.5 | 0.034 | 0.012 | 0.003 |
| 50 | 29 | 79 | 82.5 | 3.5 | 0.041 | 0.015 | 0.004 |
| 50 | 30 | 80 | 82.5 | 2.5 | 0.051 | 0.020 | 0.006 |
| 50 | 31 | 81 | 82.5 | 1.5 | 0.067 | 0.027 | 0.009 |

The results of the calculated MAP and puncture resistance given in FIGS. 15-18 and Table 4-8 can be merged to provide the minimum thicknesses of the low-modulus inner coating and high-modulus coating that yield a maximum MAP and minimum puncture resistance for input values of the the maximum modulus of low-modulus primary coating (Ep), the minimum modulus of the high-modulus coating (Es), the glass radius (Rg), and the radius of the high-modulus coating (R_{S}). Table 9a summarize the coating properties for Examples 1˜4 with cladding diameters of 100 micron and Es=1.6 GPa. Tables 9b and 9c summarize the the coating properties for Example 5-14 with cladding diameters of 100 micron and Es=2.0 GPa.

TABLE 9a
(Minimum thicknesses of the low-modulus inner coating
and high-modulus coating that provide the given values
of the maximum MAP and minimum puncture resistance).

| | Exam- | Exam- | Exam- | Exam- |
|---|---|---|---|---|
| | ple 1 | ple 2 | ple 3 | ple 4 |
| Glass Radius, R_g | 50 | 50 | 50 | 50 |
| (microns) | | | | |
| Maximum Ep (Mpa) | 0.5 | 0.35 | 0.2 | 0.2 |
| Minimum Es (Gpa) | 1.6 | 1.6 | 1.6 | 1.6 |
| Maximum MAP of | 0.05 | 0.03 | 0.03 | 0.01 |
| Trench-assisted profile | | | | |
| (dB/km) | | | | |
| Minimum Puncture | 30 | 30 | 30 | 30 |
| Resistance (g) | | | | |
| Minimum Low-modulus | 13 | 11 | 7 | 11 |
| Inner Coating Thickness, | | | | |
| t_p (microns) | | | | |
| Maximum Low-modulus | 14 | 14 | 14 | 14 |
| Inner Coating Thickness, | | | | |
| t_p (microns) | | | | |
| Minimum High-modulus | 18.5 | 18.5 | 18.5 | 18.5 |
| Coating Thickness, t_s | | | | |
| (microns) | | | | |
| Maximum High-modulus | 19.5 | 21.5 | 25.5 | 21.5 |
| Coating Thickness, t_s | | | | |
| (microns) | | | | |
| Minimum High-modulus | 64 | 64 | 64 | 64 |
| Coating Radius, R_s | | | | |
| (microns) | | | | |
| Minimum Cross | 17029 | 17029 | 17029 | 17029 |
| Sectional Area of | | | | |
| Secondary Coating | | | | |
| (sq. microns) | | | | |

TABLE 9b
(Minimum thicknesses of the low-modulus inner coating and high-modulus coating that
provide the given values of the maximum MAP and minimum puncture resistance).

| | Example 5 | Example 6 | Example 7 | Example 8 | Example 9 |
|---|---|---|---|---|---|
| Glass Radius, R_g (microns) | 50 | 50 | 50 | 50 | 50 |
| Maximum Ep (Mpa) | 0.5 | 0.35 | 0.5 | 0.35 | 0.2 |
| Minimum Es (Gpa) | 2 | 2 | 2 | 2 | 2 |
| Maximum MAP of Trench-assisted | 0.05 | 0.02 | 0.05 | 0.02 | 0.02 |
| profile (dB/km) | | | | | |
| Minimum Puncture Resistance (g) | 30 | 30 | 35 | 35 | 35 |
| Minimum Low-modulus Inner | 11 | 13 | 11 | 13 | 6 |
| Coating Thickness, t_p (microns) | | | | | |
| Maximum Low-modulus Inner | 18 | 18 | 14 | 14 | 14 |
| Coating Thickness, t_p (microns) | | | | | |
| Minimum High-modulus Coating | 14.5 | 14.5 | 18.5 | 18.5 | 18.5 |
| Thickness, t_s (microns) | | | | | |
| Maximum High-modulus Coating | 21.5 | 19.5 | 21.5 | 19.5 | 26.5 |
| Thickness, t_s (microns) | | | | | |
| Minimum High-modulus Coating | 68 | 68 | 64 | 64 | 64 |
| Radius, R_s (microns) | | | | | |
| Minimum Cross Sectional Area of | 13711 | 13711 | 17029 | 17029 | 17029 |
| Secondary Coating (sq. microns) | | | | | |

TABLE 9c
(Minimum thicknesses of the low-modulus inner coating and high-modulus coating that
provide the given values of the maximum MAP and minimum puncture_resistance).

| | Example 10 | Example 11 | Example 12 | Example 13 | Example 14 |
|---|---|---|---|---|---|
| Glass Radius, R_g (microns) | 50 | 50 | 50 | 50 | 50 |
| Maximum Ep (Mpa) | 0.2 | 0.2 | 0.1 | 0.2 | 0.1 |
| Minimum Es (Gpa) | 2 | 2 | 2 | 2 | 2 |
| Maximum MAP of Trench-assisted | 0.01 | 0.007 | 0.003 | 0.01 | 0.007 |
| profile (dB/km) | | | | | |
| Minimum Puncture Resistance (g) | 35 | 35 | 35 | 40 | 40 |
| Minimum Low-modulus Inner | 9 | 11 | 9 | 9 | 5 |
| Coating Thickness, t_p (microns) | | | | | |
| Maximum Low-modulus Inner | 14 | 14 | 14 | 9.5 | 9.5 |
| Coating Thickness, t_p (microns) | | | | | |
| Minimum High-modulus Coating | 18.5 | 18.5 | 18.5 | 23 | 23 |
| Thickness, t_s (microns) | | | | | |
| Maximum High-modulus Coating | 23.5 | 21.5 | 23.5 | 23.5 | 27.5 |
| Thickness, t_s (microns) | | | | | |
| Minimum High-modulus Coating | 64 | 64 | 64 | 59.5 | 59.5 |
| Radius, R_s (microns) | | | | | |
| Minimum Cross Sectional Area of | 17029 | 17029 | 17029 | 20521 | 20521 |
| Secondary Coating (sq. microns) | | | | | |

### Reduced Diameter Exemplary Embodiments

As discussed above, the optical fibers of the embodiments disclosed herein may have a glass diameter of about 100 microns and a reduced coating diameter may have an outer diameter of about 140 microns to about 170 microns, or about 145 microns to about 170 microns, or about 150 microns to about 170 microns, or about 155 microns to about 170 microns, or about 160 microns to about 168 microns, or about 163 microns to about 167 microns. It is noted that the outer diameter of cladding region 20 is the glass diameter of optical fiber 12 and that the outer diameter of high-modulus coating 24 may be the outer overall diameter of optical fiber 12 (when an outer pigmented outer coating layer is not applied).

In some exemplary examples, cladding region 18 has an outer diameter of about 100 microns and high-modulus coating 24 has an outer diameter between about 140 and 170 microns.

As discussed above, the reduced diameter optical fiber profile designs of the present disclosure provide particular advantages, such as, for example, a higher fiber count. However, a reduction in the cladding diameter of an optical fiber may allow some light to leak through the cladding, due to the reduced profile of the cladding. Thus, the off-set trench designs of the present disclosure have trench volumes of about 30% Δ-micron² or greater to advantageously reduce “tunneling” or “radiation” losses caused by leaking of the light through the reduced diameter cladding.

To strike a balance between microbend sensitivity and puncture resistance, the thickness r₅−₄ of the low-modulus coating is preferably in a range from about 8 microns to about 15 microns, or from about 9 microns to about 14 microns, or from about 10 microns to about 13 microns, or from about 11 microns to about 12 microns. Further, the secondary high modulus coating preferably has a thickness r₆−r₅ in a range from about 16.5 microns to about 24.5 microns, or in the range from about 17.5 microns to about 23.5 microns, or in the range from about 18.5 microns to about 22.5 microns, or in the range from 19 microns to about 22 microns, or in the range from 20 microns to 21 microns.

Thus, optical fibers in accordance with the embodiments of the present disclosure have reduced coating diameters compared to traditional optical fibers. The size reduction helps to increase the “fiber count” and fiber density within an optical fiber cable.

### Exemplary Low-Modulus and High-Modulus Coatings

Exemplary low-modulus and high-modulus coatings are discussed below, along with measurements of strength and puncture resistance of the coatings.

Low-Modulus Coating—Composition. The low-modulus coating composition includes the formulation given in Table 10 below and is typical of commercially available low-modulus coating compositions.

TABLE 10
Reference Low-modulus Coating Composition

| Component | Amount | |
|---|---|---|
| Oligomeric Material | 50.0 | wt % |
| SR504 | 46.5 | wt % |
| NVC | 2.0 | wt % |
| TPO | 1.5 | wt % |
| Irganox 1035 | 1.0 | pph |
| 3-Acryloxypropyl trimethoxysilane | 0.8 | pph |
| Pentaerythritol tetrakis(3-mercapto | 0.032 | pph |
| propionate) | | |

Where the oligomeric material was prepared as described herein from H12MDI, HEA, and PPG4000 using a molar ratio n:m:p=3.5:3.0:2.0, SR504 is ethoxylated(4)nonylphenol acrylate (available from Sartomer), NVC is N-vinylcaprolactam (available from Aldrich), TPO (a photoinitiator) is (2,4,6-trimethylbenzoyl)-diphenyl phosphine oxide (available from BASF), Irganox 1035 (an antioxidant) is benzenepropanoic acid, 3,5-bis(1,1-dimethylethyl)-4-hydroxythiodi-2,1-ethanediyl ester (available from BASF), 3-acryloxypropyl trimethoxysilane is an adhesion promoter (available from Gelest), and pentaerythritol tetrakis(3-mercaptopropionate) (also known as tetrathiol, available from Aldrich) is a chain transfer agent. The concentration unit “pph” refers to an amount relative to a base composition that includes all monomers, oligomers, and photoinitiators. For example, a concentration of 1.0 pph for Irganox 1035 corresponds to 1 g Irganox 1035 per 100 g combined of oligomeric material, SR504, NVC, and TPO.

The oligomeric material was prepared by mixing H12MDI (4,4′-methylene bis(cyclohexyl isocyanate)), dibutyltin dilaurate and 2,6-di-tert-butyl-4 methylphenol at room temperature in a 500 mL flask. The 500 mL flask was equipped with a thermometer, a CaCl₂) drying tube, and a stirrer. While continuously stirring the contents of the flask, PPG4000 was added over a time period of 30-40 minutes using an addition funnel. The internal temperature of the reaction mixture was monitored as the PPG4000 was added and the introduction of PPG4000 was controlled to prevent excess heating (arising from the exothermic nature of the reaction). After the PPG4000 was added, the reaction mixture was heated in an oil bath at about 70° C. to 75° C. for about 1 to 1½ hours. At various intervals, samples of the reaction mixture were retrieved for analysis by infrared spectroscopy (FTIR) to monitor the progress of the reaction by determining the concentration of unreacted isocyanate groups. The concentration of unreacted isocyanate groups was assessed based on the intensity of a characteristic isocyanate stretching mode near 2265 cm⁻¹. The flask was removed from the oil bath and its contents were allowed to cool to below 65° C. Addition of supplemental HEA was conducted to insure complete quenching of isocyanate groups. The supplemental HEA was added dropwise over 2-5 minutes using an addition funnel. After addition of the supplemental HEA, the flask was returned to the oil bath and its contents were again heated to about 70° C. to 75° C. for about 1 to 1½ hours. FTIR analysis was conducted on the reaction mixture to assess the presence of isocyanate groups and the process was repeated until enough supplemental HEA was added to fully react any unreacted isocyanate groups. The reaction was deemed complete when no appreciable isocyanate stretching intensity was detected in the FTIR measurement.

High-Modulus Coating—Compositions. Four curable high-modulus coating compositions (A, SB, SC, and SD) are listed in Table 11.

TABLE 11
High-modulus Coating Compositions

Composition

| Component | A | SB | SC | SD |
|---|---|---|---|---|
| PE210 (wt %) | 15.0 | 15.0 | 15.0 | 15.0 |
| M240 (wt %) | 72.0 | 72.0 | 72.0 | 62.0 |
| M2300 (wt %) | 10.0 | — | — | — |
| M3130 (wt %) | — | 10.0 | — | — |
| M370 (wt %) | — | — | 10.0 | 20.0 |
| TPO (wt %) | 1.5 | 1.5 | 1.5 | 1.5 |
| Irgacure 184 (wt %) | 1.5 | 1.5 | 1.5 | 1.5 |
| Irganox 1035 (pph) | 0.5 | 0.5 | 0.5 | 0.5 |
| DC-190 (pph) | 1.0 | 1.0 | 1.0 | 1.0 |

PE210 is bisphenol-A epoxy diacrylate (available from Miwon Specialty Chemical, Korea), M240 is ethoxylated (4) bisphenol-A diacrylate (available from Miwon Specialty Chemical, Korea), M2300 is ethoxylated (30) bisphenol-A diacrylate (available from Miwon Specialty Chemical, Korea), M3130 is ethoxylated (3) trimethylolpropane triacrylate (available from Miwon Specialty Chemical, Korea), TPO (a photoinitiator) is (2,4,6-trimethylbenzoyl)diphenyl phosphine oxide (available from BASF), Irgacure 184 (a photoinitiator) is 1-hydroxycyclohexyl-phenyl ketone (available from BASF), Irganox 1035 (an antioxidant) is benzenepropanoic acid, 3,5-bis(1,1-dimethylethyl)-4-hydroxythiodi-2,1-ethanediyl ester (available from BASF). DC190 (a slip agent) is silicone-ethylene oxide/propylene oxide copolymer (available from Dow Chemical). The concentration unit “pph” refers to an amount relative to a base composition that includes all monomers and photoinitiators. For example, for high-modulus coating composition A, a concentration of 1.0 pph for DC-190 corresponds to 1 g DC-190 per 100 g combined of PE210, M240, M2300, TPO, and Irgacure 184.

High-Modulus Coatings—Tensile Properties. The Young's modulus, tensile strength at yield, yield strength, and elongation at yield of high-modulus coatings made from high-modulus compositions A, SB, SC, and SD were measured using the technique described above. The results are summarized in Table 12.

TABLE 12
Tensile Properties of High-modulus Coatings

| | High-modulus Composition | | | |
|---|---|---|---|---|
| Property | A | SB | SC | SD |
| Young's Modulus | 2049.08 | 2531.89 | 2652.51 | 2775.94 |
| (MPa) | | | | |
| Tensile Strength | 86.09 | 75.56 | 82.02 | 86.08 |
| (MPa) | | | | |
| Yield Strength | 48.21 | 61.23 | 66.37 | 70.05 |
| (MPa) | | | | |
| Elongation at Yield | 4.60 | 4.53 | 4.76 | 4.87 |
| (%) | | | | |
| Fracture Toughness, | 0.8580 | 0.8801 | 0.9471 | 0.9016 |
| K_{c} (MPa*m^{1/2}) | | | | |

The results show that high-modulus coatings prepared from compositions SB, SC, and SD exhibited higher Young's modulus and higher yield strength than the high-modulus coating prepared from comparative composition A. Additionally, the high-modulus coatings prepared from compositions SB, SC, and SD exhibited higher fracture toughness than the high-modulus coating prepared from composition A. The higher values exhibited by composition SB, SC, and SD enable use of thinner high-modulus coatings on optical fibers without sacrificing performance. As discussed above, thinner high-modulus coatings reduce the overall diameter of the optical fiber and provide higher fiber counts in a given cross-sectional area (such as in submarine repeater).

### Exemplary Optical Fiber Embodiments

The experimental examples and principles disclosed herein indicate that sufficiently low attenuation and high puncture resistance properties can be achieved in a reduced diameter optical fiber by tailoring the refractive index profile and coating properties of the optical fiber. More specifically, the high-modulus coating provides sufficient puncture resistance for the reduced diameter fiber in spite of the smaller cross-sectional area.

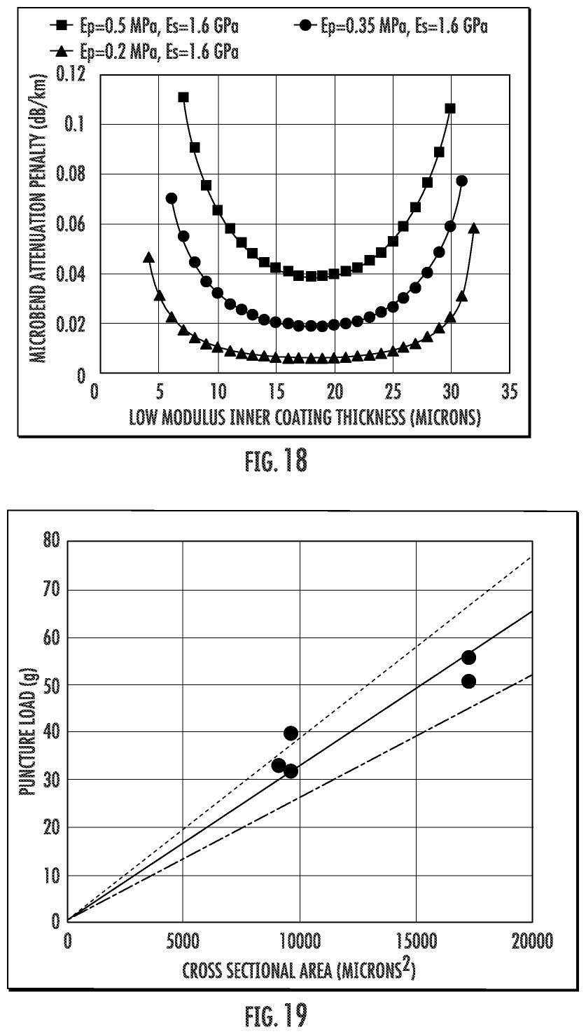

FIG. 19 is a plot of the dependence of the puncture load in grams versus the cross-sectional area of the high-modulus coating. The dashed line has a slope of 0.00263 g/microns² and corresponds to comparative fibers having a high-modulus coating having an in situ modulus of about 1500 GPa. The solid line is a linear fit to measured data for five fibers having a high-modulus coating with an in situ modulus of about 1850 GPa, The slope is 0.00328 g/microns², which is approximately equal to the slope for the reference fibers multiplied by the ratio of the in situ moduli, 1850/1500. The dotted line represents the modeled dependence of the puncture load in grams versus the cross-sectional area of a high-modulus coating having an in situ modulus of 2200 GPa. The results indicate that an increase in the in situ modulus of the high-modulus coating enables a reduction in the cross-sectional area and thickness without a significant degradation of the puncture resistance of the smaller diameter fiber.

### Fiber Draw Process

The optical fibers disclosed herein may be formed from a continuous optical fiber manufacturing process, during which a glass fiber is drawn from a heated preform and sized to a target diameter. In fibers comprising a low-modulus inner coating, the glass fiber is then cooled and directed to a coating system that applies a liquid low-modulus coating composition to the glass fiber. Two process options are viable after application of the liquid low-modulus coating composition to the glass fiber. In one process option (wet-on-dry process), the liquid low-modulus coating composition is cured to form a solidified low-modulus coating, the liquid high-modulus coating composition is applied to the cured low-modulus coating, and the liquid high-modulus coating composition is cured to form a solidified high-modulus coating. In a second process option (wet-on-wet process), the liquid high-modulus coating composition is applied to the liquid low-modulus coating composition, and both liquid coating compositions are cured simultaneously to provide solidified low-modulus and high-modulus coatings. After the fiber exits the coating system, the fiber is collected and stored at room temperature. Collection of the fiber typically entails winding the fiber on a spool and storing the spool.

In some processes, the coating system further applies a pigmented outer coating composition to the high-modulus coating and cures the pigmented outer coating composition to form a solidified pigmented outer coating. Typically, the pigmented outer coating is an ink layer used to mark the fiber for identification purposes and has a composition that includes a pigment and is otherwise similar to the high-modulus coating. The pigmented outer coating is applied to the high-modulus coating and cured. The high-modulus coating has typically been cured at the time of application of the pigmented outer coating. The low-modulus, high-modulus, and pigmented outer coating compositions can be applied and cured in a common continuous manufacturing process. Alternatively, the low-modulus and high-modulus coating compositions are applied and cured in a common continuous manufacturing process, the coated fiber is collected, and the pigmented outer coating composition is applied and cured in a separate offline process to form the pigmented outer coating.

### Coating Application, Coating Material Viscosity and Coating Die Size

In some embodiments, optical fiber drawn from a pre-form within a draw furnace, is passed through a coating system where a polymer coating is applied to the optical fiber. The coating system may comprise an entrance and a sizing die. Disposed between the entrance and the sizing die is a coating chamber. The coating chamber is filled with the polymer coating material in liquid form. The optical fiber enters the coating system through the entrance and passes through the coating chamber where the polymer coating material is applied to the surface of the optical fiber. The optical fiber then passes through the sizing die where any excess coating material is removed as the optical fiber exits the coating system to achieve a coated optical fiber of a specified diameter in accordance of some embodiments described herein.

The presently disclosed intermittently bonded optical fiber ribbons are particularly suitable for non-contact stripping methods, such as hot gas or CO₂ laser stripping. In particular, the optical fibers in the subunits are only joined by a single layer of matrix material, and the subunits are only intermittently joined together. Thus, for example, the hot gas can more easily flow around the subunits, allowing for “window stripping” the optical fibers to completely remove the coatings from a section of the of the fiber array. In embodiments, the optical fibers of the ribbon are stripped of all coatings and down to the glass over a section (e.g., 10 mm). This method involves directing a jet or stream of hot gas onto a region of a coated optical fiber such that the bubbles form in the primary coating, expand until they can no longer be contained by the secondary coating, and then explode. If performed properly, both coatings layers are removed cleanly, leaving a pristine glass surface with little to no degradation of the material strength. A thick or dual-layer ribbon matrix will create more of a barrier for the hot gas (or laser radiation) to penetrate, and more material needs to be removed to expose the bare glass fibers. The simpler structure of the intermittently-bonded ribbon disclosed herein provides an advantage for non-contact stripping methods, such as those that utilize hot gas, a hot wire, or a CO₂ laser.

Still further, the optical fibers are of a sufficiently small diameter to interface with new connectors, such as 32-fiber MPO connectors. These connectors typically have two rows of 16 holes. Current cables use sixteen individually colored fibers in micro-modules to feed into one 32-fiber connector. The assembly process is slow and error prone because of the requirement to arrange groups of 16 fibers into two rows to slide into the MPO ferrule. Two 16-fiber intermittently-bonded ribbons having small diameter fibers as disclosed herein can be packed into one micro module, which would allow direct connectorization of the 32 fibers to the MPO ferrule.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. An optical fiber ribbon, comprising:
a plurality of subunits each comprising a subunit coating surrounding at least one optical fiber;
a plurality of bonds intermittently formed between adjacent subunits of the plurality of subunits;
wherein each bond of the plurality of bonds has a unique longitudinal position along a length of the optical fiber ribbon such that no other bond of the plurality of bonds is located at the unique longitudinal position;
wherein each of the at least one optical fiber comprises a core region, a cladding region surrounding the core region, a primary coating surrounding the cladding region, and a secondary coating surrounding the primary coating;
wherein the cladding region defines a glass diameter in a range from 90 microns to 110 microns and wherein the secondary coating defines an outer diameter of 140 microns to 170 microns; and
wherein the cladding region comprises a depressed index region comprising a trench volume of −20% Δ-micron².

2. The optical fiber ribbon of claim 1, wherein a puncture resistance of the optical fiber is at least 25 g.

3. The optical fiber ribbon of claim 1, wherein the primary coating comprises a thickness between the cladding region and the secondary coating that is in a range from 8 micron to 15 micron.

4. The optical fiber ribbon of claim 3, wherein the secondary coating defines a thickness that is in a range from 16.5 micron to 24.5 micron.

5. The optical fiber ribbon of claim 1, wherein the primary coating comprises a Young's modulus of 0.5 MPa or less.

6. The optical fiber ribbon of claim 1, wherein the secondary coating comprises a Young's modulus of 1500 MPa or greater.

7. The optical fiber ribbon of claim 1, wherein the glass diameter is in a range of 95 microns to 105 microns.

8. The optical fiber ribbon of claim 1, wherein the outer diameter is in a range of 160 microns to 170 microns.

9. An optical fiber ribbon, comprising:
a plurality of intermittently bonded subunits comprising at least one optical fiber;
wherein each of the at least one optical fiber comprises a core region, a cladding region surrounding the core region, a primary coating surrounding the cladding region, and a secondary coating surrounding the primary coating;
wherein the cladding region defines a glass diameter in a range from 90 microns to 110 microns;
wherein the primary coating has a thickness between the cladding region and the secondary coating in a range of 8 microns to 15 microns and has a Young's modulus of 0.5 MPa or less; and
wherein the secondary coating has a thickness in a range of 16.5 microns to 24.5 microns and has a Young's modulus of 1500 MPa or greater.

10. The optical fiber ribbon of claim 9, wherein the secondary coating defines an outer diameter of the optical fiber of 140 microns to 170 microns.

11. The optical fiber ribbon of claim 9, wherein the cladding region comprises a depressed index region comprising a trench volume of −30% Δ-micron².

12. The optical fiber ribbon of claim 9, wherein a puncture resistance of the optical fiber is at least 25 g.

13. The optical fiber ribbon of claim 9, wherein the subunits comprise intermittent bonds between adjacent subunits of the plurality of intermittently bonded subunits and wherein the intermittent bonds do no overlap across a width of the optical fiber ribbon.

14. The optical fiber ribbon of claim 9, wherein a microbend attenuation penalty of the optical fiber is calculated by equation:
$$M A P = {C}_{0} {f}_{0} σ \frac{{f}_{RIP} {f}_{g} ( {E}_{g} , {R}_{g} ) {f}_{p} ( {E}_{p} , {t}_{p} )}{{f}_{cs} ( \frac{{E}_{s}}{{E}_{p}} , {R}_{s} , {t}_{s} )} ,$$
wherein f₀ is an average lateral pressure of an external surface in contact with the secondary coating, wherein σ is a standard deviation of a roughness of the external surface in contact with the secondary coating, wherein
$${C}_{0} = 4 \times {{10}^{25} [ {( \frac{π}{4} )}^{2.625} ]}^{- 1} ,$$
and wherein
$${f}_{g} = \frac{1}{{E}_{g}^{2} {R}_{g}^{6}} ,$$
and wherein
$${f}_{p} = \frac{{E}_{p}}{{t}_{p}^{2}} ,$$
and wherein
$${f}_{cs} = {[ 1 + \frac{{E}_{s}}{{E}_{p}} {( \frac{{t}_{s}}{{R}_{s}} )}^{3} ]}^{0.375} {\{ \frac{{E}_{s}}{{E}_{p}} [ {R}_{s}^{4} - {( {R}_{s} - {t}_{s} )}^{4} ] \}}^{0.625} ,$$
wherein R_{g} is a radius of the glass, Rₛ is the outer radius of the secondary coating, tₚ is the thickness of the primary coating, tₛ is the thickness of the secondary coating, E_{g} is the elastic moduli of the secondary coating; and
wherein the microbend attenuation penalty is less than 0.01 dB/km.

15. A method of preparing an optical fiber ribbon, comprising:
arranging a plurality of optical fibers adjacent to each other along a length of the optical fiber ribbon;
applying a coating comprising a first material around the plurality of optical fibers to create a plurality of subunits, each subunit of the plurality of subunits comprising at least one optical fiber;
intermittently applying a plurality of bonds comprising a second material between adjacent subunits of the plurality of subunits, wherein the second material diffuses into the first material creating a diffusion zone of the second material in the first material and wherein each bond of the plurality of bonds is located at a unique longitudinal position along the length of the optical fiber ribbon;
curing the first material and the second material;
wherein each of the plurality of optical fibers comprises a core region, a cladding region surrounding the core region, a primary coating surrounding the cladding region, and a secondary coating surrounding the primary coating;
wherein the cladding region defines a glass diameter in a range from 90 microns to 110 microns and wherein the secondary coating defines an outer diameter of 140 microns to 170 microns; and
wherein the cladding region comprises a depressed index region comprising a trench volume of −20% Δ-micron².

16. The method of claim 15, wherein a center-to-center distance of adjacent optical fibers is at most 170 microns.

17. The method of claim 15, wherein a puncture resistance of the optical fiber is at least 25 g.

18. The method of claim 15, wherein the primary coating comprises a thickness between the cladding region and the secondary coating that is in a range from 8 micron to 15 micron.

19. The method of claim 18, wherein the secondary coating defines a thickness that is in a range from 16.5 micron to 24.5 micron.

20. The optical fiber ribbon of claim 1, wherein the primary coating comprises a Young's modulus of 0.5 MPa or less and wherein the secondary coating comprises a Young's modulus of 1500 MPa or greater.
